(19) United States
(12) Patent Application Publication
(10) Pub. No.: US 2025/0203611 A1
(43) Pub. Date: Jun. 19, 2025

(54) APPARATUS AND METHODS FOR SCHEDULING INTERNET-OF-THINGS DEVICES

(71) Applicant: Huawei Technologies Co., Ltd., Shenzhen (CN)

(72) Inventors: Yiqun Ge, Kanata (CA); Harsh Aurora, Kanata (CN); Wuxian Shi, Kanata (CA); Wen Tong, Ottawa (CA); Adam Christian Cavatassi, Mississauga (CA)

(21) Appl. No.: 19/040,464

(22) Filed: Jan. 29, 2025

Related U.S. Application Data
(63) Continuation of application No. PCT/CN2022/110351, filed on Aug. 4, 2022.

(51) Int. Cl. H04W 72/1268; H04W 72/121

(52) U.S. Cl. CPC H04W 72/1268; H04W 72/121

(57) ABSTRACT

Methods and apparatus for scheduling uplink transmissions based on contributiveness to a downstream task are provided. Multiple devices to schedule for uplink transmission are selected from a set of candidate devices based on a contributiveness metric for each device. The contributiveness metric for each device is related to a downstream task in the wireless communication network and is indicative of how well the device is able to successfully transmit information to the network for the downstream task and how informative the information provided by the device is for the downstream task. The contributiveness metric of a candidate device may be learned via machine learning using a deep neural network.

### CROSS-REFERENCE TO RELATED APPLICATION

This application is a continuation of International Application No. PCT/CN2022/110351, entitled “APPARATUS AND METHODS FOR SCHEDULING INTERNET-OF-THINGS DEVICES,” filed on Aug. 4, 2022, which is hereby incorporated by reference in its entirety.

### TECHNICAL FIELD

The present disclosure relates to wireless communication generally, and, in particular embodiments, to methods and apparatuses for scheduling multiple devices in a wireless communication network.

### BACKGROUND

In a typical modern radio communication system such as wide band code division multiple access (WCDMA), long-term evolution (LTE), 5th Generation (5G), Wi-Fi and so on, a number of electronic devices (EDs) (which may also be referred to as clients, terminals, user equipment (UEs), moving station, etc.) may be connected to or associated with a base station (BS) (which may also be referred to as a base transceiver station (BTS), Node-B, eNodeB, gNB, access point (AP), transmission point (TP), etc.) over-the-air. As the number and density of EDs increase, it becomes challenging to support good quality wireless communications using conventional wireless systems.

Machine-to-machine (M2M) communications may be one type of high density wireless communications. M2M communications is a technology that realizes a network for collecting information from devices (e.g., sensors, smart meters, Internet of Things (IoT) devices, and/or other low-end devices) that are typically massively and densely deployed, and for transmitting information captured by those devices to other applications in the network. M2M networks may be wired or wireless and may have a relatively large geographical distribution (e.g., across a country or across the world). M2M communications typically do not involve direct human intervention for information collection.

5G New Radio (NR) systems include features to support massive machine type communications (mMTC) that connects large numbers (e.g., millions or billions) of IoT equipment by a wireless system. It is expected in the near future that the amount of M2M communications conducted over-the-air will bypass those of human-related communications. For example, it is expected that 6th Generation (6G) systems will connect more IoT devices than mobile phones. In 6G, a high-density IoT deployment is expected to give birth to many innovative applications, thereby profoundly reshaping many industries and societies. Some predictions expect that the deployment density in 6G systems may reach 109 IoT devices per 1 km². It would present a challenge for 6G systems to support such a high-density IoT deployment in which thousands or tens of thousands of IoT devices could potentially transmit their data back to the network simultaneously through shared radio channels.

Accordingly, it would be desirable to provide a way to improve wireless communications, including improvements to accommodate and optimize scheduling for large numbers of densely deployed IoT devices.

### SUMMARY

According to a first broad aspect of the present disclosure, there is provided herein a method for scheduling uplink transmissions in a wireless communication network. The method according to the first broad aspect of the present disclosure may include selecting, from a set of candidate devices, a first plurality of devices to schedule for uplink transmission, the selecting of the first plurality of devices being based on a first contributiveness metric for each device. The first contributiveness metric for each device may be related to a first downstream task in the wireless communication network. For example, the first contributiveness metric for a given device may be indicative of: i) how well the device is able to successfully transmit information to the network for the first downstream task; and ii) how informative the information provided by the device is for the first downstream task. The method according to the first broad aspect of the present disclosure may further include transmitting scheduling information indicating uplink radio resources allocated for the first plurality of devices.

Providing contributiveness-based scheduling in accordance with the first broad aspect of the present disclosure can have several advantages. For example, contributiveness-based scheduling may avoid scheduling the least contributive devices, e.g., due to their disadvantageous observation positions or due to their severe path losses or both, which avoids the wasted radio resources that may otherwise be allocated to the least contributive devices if conventional request-based proportional fairness were utilized, as discussed in further detail herein. Moreover, because the contributiveness metric may be specific to a given downstream task, contributiveness-based scheduling may take into account a device's varying contributiveness from one task to another, e.g., a device quite contributive for one task may be irrelevant for another task.

In some embodiments, the uplink radio resources are allocated for the first plurality of devices by allocating, for each device of the first plurality of devices, uplink radio resources to the device based on the first contributiveness metric for the device. For example, a device having a first contributiveness metric indicative of a higher contributiveness for the first task may be allocated more uplink radio resources than a device having a first contributiveness metric indicative of a lower contributiveness for the first task.

In some embodiments, the method according to the first broad aspect of the present disclosure further includes selecting, from the set of candidate devices, a second plurality of devices to schedule for uplink transmission. The selecting of the second plurality of devices may be based on a second contributiveness metric for each device. For example, the second contributiveness metric for each device may be related to a second downstream task in the wireless communication network different from the first downstream task. For example, the second contributiveness metric may be indicative of: i) how well the device is able to successfully transmit information to the network for the second downstream task; and ii) how informative the information provided by the device is for the second downstream task. Scheduling information indicating uplink radio resources allocated for the second plurality of devices may then be transmitted for the second plurality of devices.

In some embodiments, the first contributiveness metric of a candidate device for the first downstream task is learned via machine learning using a machine learning module. For example, the machine learning module may include a deep neural network (DNN) trained using raw test data received from at least a subset of the candidate devices as ML module input and one or more parameters for the first downstream task as ML module output to satisfy a training target related to the first downstream task. For example, in some embodiments the DNN may be configured as an autoencoder comprising at least two layers of neurons, wherein a first layer of the autoencoder is a linear fully-connected layer comprising K neurons having N inputs corresponding to the set of N candidate devices and K outputs, each of the K outputs of the first layer being a weighted linear combination of the N inputs, wherein, once trained, the first layer of the autoencoder is configured as an N-to-K selector that selects K inputs from the set of N inputs, wherein K<N. In such embodiments, one or more layers after the first layer of the autoencoder may be configured as a decoder to perform decoding for the first downstream task utilizing the K outputs from the first layer as inputs to the decoder.

In some embodiments, training of the autoencoder is based on stochastic gradient descent (SGD) backpropagation from the last layer of the autoencoder to the first layer of the autoencoder to satisfy the training target related to the first downstream task.

In some embodiments, the first plurality of devices to schedule for uplink transmission are selected based on the weights of the trained first layer of the autoencoder.

It is a nondeterministic polynomial (NP) problem to jointly optimize both the informativeness metric of a device for a task and the condition of its channel connections to the network. The advantage of utilizing a DNN as described above is that a backward propagation training algorithm, such as SGD could propagate the task (i.e., the training objective) from the last layer to the first layer, which means that all the neurons of the DNN work together to achieve the task. The first layer will regulate the scheduler and the rest layers will fuse and process the incoming information from multiple devices. Besides, the information about the path-loss rates among the devices are embedded in the training & test data set. As data-driven, this channel path-loss factor would be implicitly considered into the optimization by DNN. The autoencoder (DNN)-based scheduling methods disclosed herein provide a global optimization platform to do the joint optimization.

In some embodiments, training of the autoencoder polarizes the weights in the first layer of the autoencoder such that, for each neuron of the K neurons in the first layer of the autoencoder, the output of the neuron is a weighted combination of the N inputs of the neuron, but only one of the N weights is proximate to a value of 1 and the remaining N−1 weights are proximate to a value of 0. For example, training of the autoencoder may utilize a continuous relaxation of a discrete distribution (concrete distribution) parameterized by a temperature parameter, wherein the temperature parameter is reduced over the course of multiple training epochs so that the weights of the first layer of the autoencoder become increasingly polarized. In some such embodiments, for each neuron of the K neurons in the first layer of the autoencoder, the candidate device corresponding to the input for which the trained weight of the neuron is proximate to a value of 1 is considered to have been selected by that neuron. For example, in some embodiments the number of neurons, K, in the first layer of the autoencoder may be equal to Kₘᵢₙ for the first downstream task, wherein Kₘᵢₙ is a downstream task-specific value, and wherein Kₘᵢₙ for the first downstream task is identified during training of the autoencoder for the first downstream task and indicates a minimum number of neurons in the first layer that enable the training target related to the first downstream task to be satisfied without having any of the candidate devices be selected by more than one of the neurons in the first layer. For example, in some embodiments Kₘᵢₙ for the first downstream task may be determined during training of the autoencoder for the first downstream task by training multiple versions of the autoencoder using the same raw test data as input to the autoencoder and the same training target related to the first downstream task but with a different number of neurons in the first layer of the autoencoder.

In some embodiments, at least one of the candidate devices may be selected by more than one of the K neurons in the first layer. In some such embodiments, the first contributiveness metric for each candidate device may be based on the number of times that the candidate device is selected in the first layer of the autoencoder.

In some embodiments, the method according to the first broad aspect of the present disclosure further includes grouping the candidate devices into a plurality of groups based on the number of times that the candidate device is selected in the first layer of the autoencoder, the plurality of groups comprising at least a primary group and a secondary group. For example, candidate device grouped into the primary group may be selected in the first layer of the autoencoder a greater number of times than candidate devices grouped into the secondary group. In such embodiments, selecting the first plurality of devices to schedule for uplink transmission may include selecting the primary group of devices and transmitting uplink scheduling information for the first plurality of devices may include transmitting primary uplink scheduling information for the primary group of devices. In some such embodiments, each of the candidate devices grouped into the secondary group may be selected at least once in the first layer of the autoencoder.

In some embodiments, the method according to the first broad aspect of the present disclosure further includes receiving uplink transmissions from devices in the primary group of devices in accordance with the primary uplink scheduling information. In some such embodiments, the received uplink transmissions from the primary group of devices may be utilized as inputs to the trained decoder to perform decoding for the first downstream task.

In some embodiments, the method according to the first broad aspect of the present disclosure further includes determining one or more confidence metrics based on the decoding for the first downstream task utilizing the received uplink transmissions from the primary group of devices as inputs to the trained decoder. In some such embodiments, the method may further include determining, based on the one or more confidence metrics, whether to transmit secondary uplink scheduling information for the secondary group of devices. For example, determining whether to transmit secondary uplink scheduling information for the secondary group of devices may include determining not to transmit secondary uplink scheduling information for the secondary group of devices after determining that the one or more confidence metrics indicate sufficient confidence in a result of the decoding for the first downstream task utilizing the received uplink transmissions from the primary group of devices as inputs to the trained decoder.

In some embodiments, the method according to the first broad aspect of the present disclosure further includes, after determining that the one or more confidence metrics indicate insufficient confidence in a result of the decoding for the first downstream task utilizing the received uplink transmissions from the primary group of devices as inputs to the trained decoder, transmitting secondary uplink scheduling information for the secondary group of devices, the secondary uplink scheduling information indicating, for each device of the secondary group of devices, uplink radio resources allocated to the device. In some such embodiments, the method may further include receiving uplink transmissions from devices in the secondary group of devices in accordance with the secondary uplink scheduling information, and utilizing the received uplink transmissions from the primary group of devices and the received uplink transmissions from the secondary group of devices as inputs to the trained decoder to perform decoding for the first downstream task. In some embodiments, determining one or more confidence metrics may include determining one or more softmax values.

Corresponding apparatuses and devices are disclosed for performing the methods.

For example, according to another aspect of the disclosure, a network device is provided that includes a processor and a memory storing processor-executable instructions that, when executed, cause the processor to carry out a method according to the first broad aspect of the present disclosure described above.

According to other aspects of the disclosure, an apparatus including one or more units for implementing any of the method aspects as disclosed in this disclosure is provided. The term “units” is used in a broad sense and may be referred to by any of various names, including for example, modules, components, elements, means, etc. The units can be implemented using hardware, software, firmware or any combination thereof.

### BRIEF DESCRIPTION OF THE DRAWINGS

Reference will now be made, by way of example only, to the accompanying drawings which show example embodiments of the present application, and in which:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates illustrates four EDs communicating with a network device in a communication system, according to one embodiment;

FIG. 6A illustrates an example of a neural network with multiple layers of neurons, according to one embodiment;

FIG. 6B illustrates an example of a neuron that may be used as a building block for a neural network, according to one embodiment;

FIG. 7 illustrates an example of a neural network configured as an autoencoder, according to one embodiment;

FIG. 8 illustrates an entropy of a 2-dimensional (2-device) request distribution;

FIG. 9 illustrates an example of an Internet of Things (IoT) deployment scenario in which multiple IoT devices are measuring or observing a common object;

FIG. 10 illustrates the potential impact of unequal channel conditions in the IoT deployment scenario of FIG. 9;

FIG. 11A and FIG. 11B illustrate examples of the different subsets of devices that may be scheduled for a classification task and a detection task in the IoT deployment scenario of FIG. 9;

FIG. 12 illustrates an example of the IoT deployment of FIG. 10 in which several devices are experiencing high erasure channel conditions and thus may be incapable of successfully transmitting data to the network;

FIG. 13 illustrates an example of a DNN configured as an autoencoder that includes a first scheduling layer that functions as a scheduler and a number of decoding layers that function as a fuser and processor for the information received from devices selected by the scheduling layer, according to one embodiment;

FIG. 14 illustrates an example of epoch-by-epoch cooling during training, according to one embodiment;

FIG. 15 illustrates an example of the repeated selection of contributive devices that can occur when the output dimension K of the scheduling layer is greater than Kₘᵢₙ for a given task, according to one embodiment;

FIG. 16 illustrates an example of a scenario in which the output dimension K of the scheduling layer is much greater than Kₘᵢₙ and the ranking of contributive devices that can be done based on the number of times each contributive device is chosen by the scheduling layer, according to one embodiment;

FIG. 17 illustrates an example in which contributive devices have been grouped based on their contributiveness rankings and the groups are then incrementally scheduled as needed in order to confidently fulfill a downstream task, according to one embodiment;

FIG. 18 illustrates an example of a less contributive device acting as a relay for a more contributive device experiencing poor channel conditions, according to one embodiment;

FIG. 19 illustrates an example of a uniform deployment of 784 sensors or devices in a 28×28 array to observe a region, according to one embodiment.

FIG. 20 illustrates the setup of a concrete encoder of size K and a decoder that was used to simulate the deployment scenario of FIG. 19 using the MNIST image data set as input data, according to one embodiment.

FIG. 21 illustrates the implementation of the decoder of FIG. 20, according to one embodiment.

FIG. 22 shows MNIST handwritten digit input images;

FIG. 23 shows a plot of simulated accuracy percentages vs. erasure probability percentages for a 10-class classification task for different values of encoder size output K, according to one embodiment;

FIG. 24 shows reconstructed MNIST images with K=128/256 for different erasure probability percentages, according to one embodiment;

FIG. 25 shows a plot of simulated accuracy percentages vs. erasure probability percentages for a reconstruction task for different values of encoder size output K, according to one embodiment;

FIG. 26 shows a plot of simulated accuracy percentages vs. erasure probability percentages for a detection task for different values of encoder size output K, according to one embodiment;

FIG. 27 shows the selected sets of devices in the 28×28 array for different values of encoder size output K and a 0% erasure probability percentage for a classification task, according to one embodiment;

FIG. 28 shows the selected sets of devices in the 28×28 array for different values of encoder size output K and a 50% erasure probability percentage for the classification task, according to one embodiment;

FIG. 29 shows the selected sets of devices in the 28×28 array for different values of encoder size output K and a 0% erasure probability percentage for a reconstruction task, according to one embodiment;

FIG. 30 shows the selected sets of devices in the 28×28 array for different values of encoder size output K and a 0% erasure probability percentage for a detection task, according to one embodiment;

FIG. 31 shows an example of a non-uniform erasure channel that was used in a second set of simulations, according to one embodiment;

FIG. 32 shows an example of the transmission results over the non-uniform erasure channel shown in FIG. 31;

FIG. 33 shows a plot of simulated accuracy percentages vs. encoder size output K over the non-uniform erasure channel shown in FIG. 31 for a 10-class classification task for different values of erasure percentage probability, according to one embodiment;

FIG. 34 shows the selected sets of devices in the 28×28 array for different values of encoder size output K over the non-uniform erasure channel shown in FIG. 31 for the classification task, according to one embodiment;

FIG. 35 shows a plot of simulated accuracy percentages vs. encoder size output K over the non-uniform erasure channel shown in FIG. 31 for a reconstruction task for different values of erasure percentage probability, according to one embodiment;

FIG. 36 shows the selected sets of devices in the 28×28 array for different values of encoder size output K over the non-uniform erasure channel shown in FIG. 31 for the reconstruction task, according to one embodiment;

FIG. 37 shows reconstructed MNIST images with K=32/128/256/512 over the non-uniform erasure channel shown in FIG. 31, according to one embodiment;

FIG. 38 shows a plot of simulated accuracy percentages vs. encoder size output K over the non-uniform erasure channel shown in FIG. 31 for a detection task for different values of erasure percentage probability, according to one embodiment;

FIG. 39 shows the selected sets of devices in the 28×28 array for different values of encoder size output K over the non-uniform erasure channel shown in FIG. 31 for the detection task, according to one embodiment;

FIG. 40 shows a plot of simulated accuracy percentages vs. encoder size output K and a 0% erasure probability percentage with HARQ training for a 10-class classification task, according to one embodiment;

FIG. 41 shows the selected sets of devices in the 28×28 array for different values of encoder size output K and a 0% erasure probability percentage with HARQ training for the classification task, according to one embodiment;

FIG. 42 shows a plot of simulated accuracy percentages vs. encoder size output K and a 0% erasure probability percentage with HARQ training for a reconstruction task, according to one embodiment;

FIG. 43 shows the selected sets of devices in the 28×28 array for different values of encoder size output K and a 0% erasure probability percentage with HARQ training for the reconstruction task, according to one embodiment;

FIG. 44 shows a plot of simulated accuracy percentages vs. encoder size output K and a 0% erasure probability percentage with HARQ training for a detection task, according to one embodiment; and

FIG. 45 shows the selected sets of devices in the 28×28 array for different values of encoder size output K and a 0% erasure probability percentage with HARQ training for the detection task, according to one embodiment.

Similar reference numerals may have been used in different figures to denote similar components.

### DETAILED DESCRIPTION

For illustrative purposes, specific example embodiments will now be explained in greater detail below in conjunction with the figures.

### Example Communication Systems and Devices

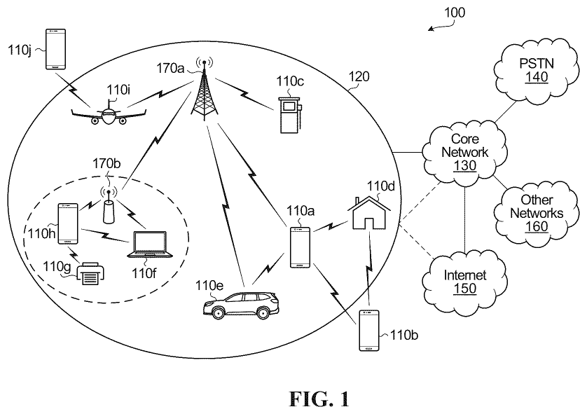

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

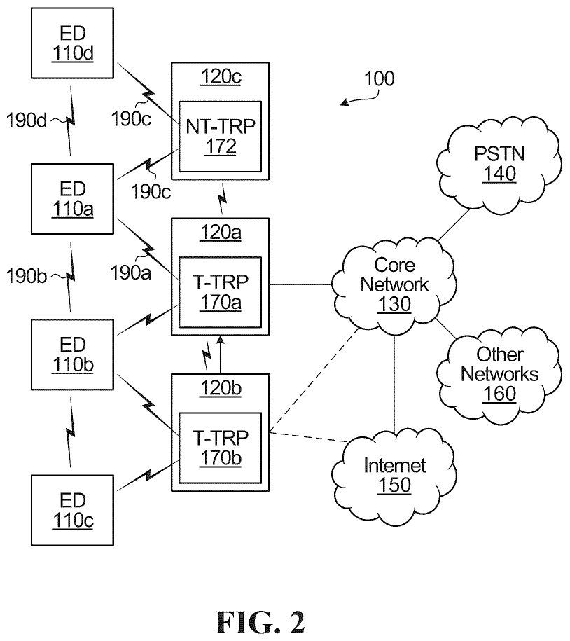

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and incorporate multiple transceivers necessary to support such.

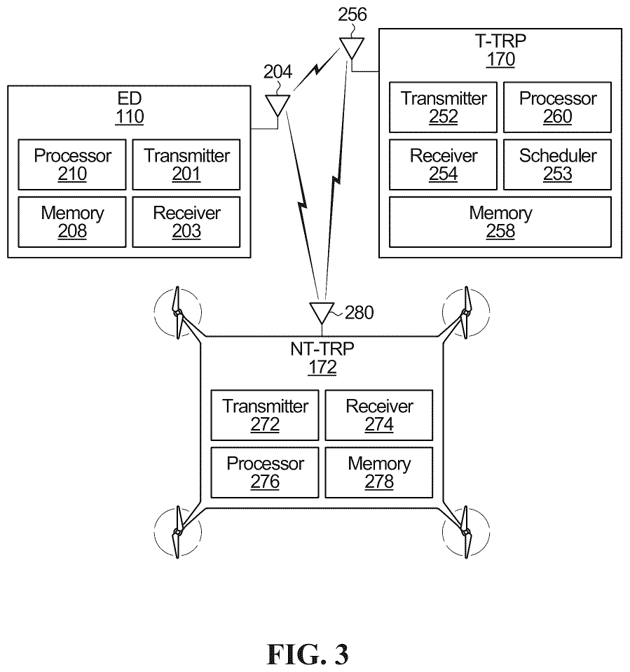

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

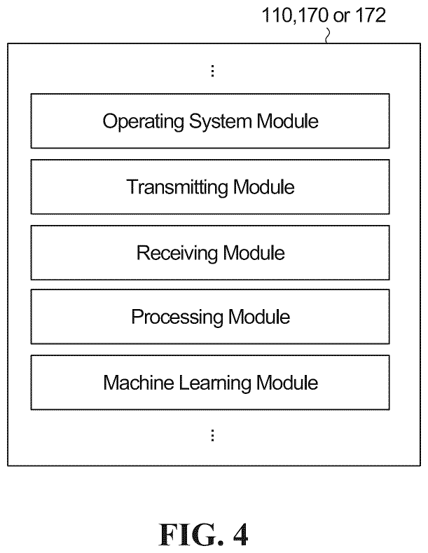

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control signaling is discussed herein in some embodiments. Control signaling may sometimes instead be referred to as signaling, or control information, or configuration information, or a configuration. In some cases, control signaling may be dynamically indicated, e.g. in the physical layer in a control channel. An example of control signaling that is dynamically indicated is information sent in physical layer control signaling, e.g. downlink control information (DCI). Control signaling may sometimes instead be semi-statically indicated, e.g. in RRC signaling or in a MAC control element (CE). A dynamic indication may be an indication in lower layer, e.g. physical layer/layer 1 signaling (e.g. in DCI), rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling, RRC signaling, and/or a MAC CE. Dynamic signaling, as used herein, may refer to signaling that is dynamic, e.g. physical layer control signaling sent in the physical layer, such as DCI.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:
A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cell/Carrier/Bandwidth Parts (BWPs)/Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage ½ of the total mean transmitted power, for example, the value of □/2 is taken as 0.5%.

The carrier, the BWP, or the occupied bandwidth may be signaled by a network device (e.g. base station) dynamically, e.g. in physical layer control signaling such as Downlink Control Information (DCI), or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

Artificial Intelligence (AI) and/or Machine Learning (ML)

The number of new devices in future wireless networks is expected to increase exponentially and the functionalities of the devices are expected to become increasingly diverse. Also, many new applications and use cases are expected to emerge with more diverse quality of service demands than those of 5G applications/use cases. These will result in new key performance indications (KPIs) for future wireless networks (for example, a 6G network) that can be extremely challenging. AI technologies, such as ML technologies (e.g., deep learning), have been introduced to telecommunication applications with the goal of improving system performance and efficiency.

In addition, advances continue to be made in antenna and bandwidth capabilities, thereby allowing for possibly more and/or better communication over a wireless link. Additionally, advances continue in the field of computer architecture and computational power, e.g. with the introduction of general-purpose graphics processing units (GP-GPUs). Future generations of communication devices may have more computational and/or communication ability than previous generations, which may allow for the adoption of AI for implementing air interface components. Future generations of networks may also have access to more accurate and/or new information (compared to previous networks) that may form the basis of inputs to AI models, e.g.: the physical speed/velocity at which a device is moving, a link budget of the device, the channel conditions of the device, one or more device capabilities and/or a service type that is to be supported, sensing information, and/or positioning information, etc. To obtain sensing information, a TRP may transmit a signal to target object (e.g. a suspected UE), and based on the reflection of the signal the TRP or another network device computes the angle (for beamforming for the device), the distance of the device from the TRP, and/or doppler shifting information. Positioning information is sometimes referred to as localization, and it may be obtained in a variety of ways, e.g. a positioning report from a UE (such as a report of the UE's GPS coordinates), use of positioning reference signals (PRS), using the sensing described above, tracking and/or predicting the position of the device, etc.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

In some embodiments, an AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

In some embodiments herein, new protocols and signaling mechanisms are provided for operating within and switching between different modes of operation for AI training, including between training and normal operation modes, and for measurement and feedback to accommodate the different possible measurements and information that may need to be fed back, depending upon the implementation.

### AI Training

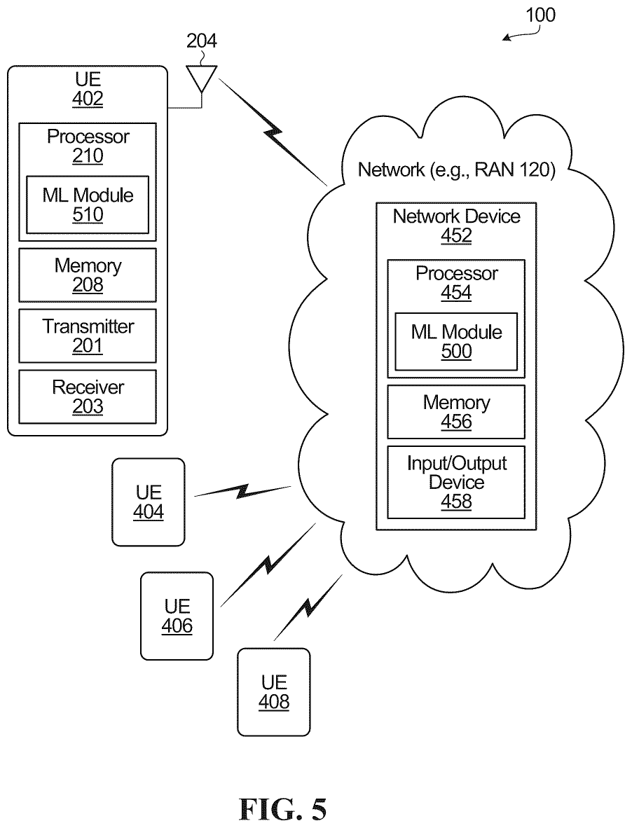

Referring again to FIGS. 1 and 2, embodiments of the present disclosure may be used to implement AI training involving two or more communicating devices in the communication system 100. For example, FIG. 5 illustrates four EDs communicating with a network device 452 in the communication system 100, according to one embodiment. The four EDs are each illustrated as a respective different UE, and will hereafter be referred to as UEs 402, 404, 406, and 408. However, the EDs do not necessarily need to be UEs.

The network device 452 is part of a network (e.g. a radio access network 120). The network device 452 may be deployed in an access network, a core network, or an edge computing system or third-party network, depending upon the implementation. The network device 452 might be (or be part of) a T-TRP or a server. In one example, the network device 452 can be (or be implemented within) T-TRP 170 or NT-TRP 172. In another example, the network device 452 can be a T-TRP controller and/or a NT-TRP controller which can manage T-TRP 170 or NT-TRP 172. In some embodiments, the components of the network device 452 might be distributed. The UEs 402, 404, 406, and 408 might directly communicate with the network device 452, e.g. if the network device 452 is part of a T-TRP serving the UEs 402, 404, 406, and 408. Alternatively, the UEs 402, 404, 406, and 408 might communicate with the network device 352 via one or more intermediary components, e.g. via a T-TRP and/or via a NT-TRP, etc. For example, the network device 452 may send and/or receive information (e.g. control signaling, data, training sequences, etc.) to/from one or more of the UEs 402, 404, 406, and 408 via a backhaul link and wireless channel interposed between the network device 452 and the UEs 402, 404, 406, and 408.

Each UE 402, 404, 406, and 408 includes a respective processor 210, memory 208, transmitter 201, receiver 203, and one or more antennas 204 (or alternatively panels), as described above. Only the processor 210, memory 208, transmitter 201, receiver 203, and antenna 204 for UE 402 are illustrated for simplicity, but the other UEs 404, 406, and 408 also include the same respective components.

For each UE 402, 404, 406, and 408, the communications link between that UE and a respective TRP in the network is an air interface. The air interface generally includes a number of components and associated parameters that collectively specify how a transmission is to be sent and/or received over the wireless medium.

The processor 210 of a UE in FIG. 5 implements one or more air interface components on the UE-side. The air interface components configure and/or implement transmission and/or reception over the air interface. Examples of air interface components are described herein. An air interface component might be in the physical layer, e.g. a channel encoder (or decoder) implementing the coding component of the air interface for the UE, and/or a modulator (or demodulator) implementing the modulation component of the air interface for the UE, and/or a waveform generator implementing the waveform component of the air interface for the UE, etc. An air interface component might be in or part of a higher layer, such as the MAC layer, e.g. a module that implements channel prediction/tracking, and/or a module that implements a retransmission protocol (e.g. that implements the HARQ protocol component of the air interface for the UE), etc. The processor 210 also directly performs (or controls the UE to perform) the UE-side operations described herein.

The network device 452 includes a processor 454, a memory 456, and an input/output device 458. The processor 454 implements or instructs other network devices (e.g. T-TRPs) to implement one or more of the air interface components on the network side. An air interface component may be implemented differently on the network-side for one UE compared to another UE. The processor 454 directly performs (or controls the network components to perform) the network-side operations described herein.

The processor 454 may be implemented by the same or different one or more processors that are configured to execute instructions stored in a memory (e.g. in memory 456). Alternatively, some or all of the processor 454 may be implemented using dedicated circuitry, such as a programmed FPGA, a GPU, or an ASIC. The memory 456 may be implemented by volatile and/or non-volatile storage. Any suitable type of memory may be used, such as RAM, ROM, hard disk, optical disc, on-processor cache, and the like.

The input/output device 458 permits interaction with other devices by receiving (inputting) and transmitting (outputting) information. In some embodiments, the input/output device 458 may be implemented by a transmitter and/or a receiver (or a transceiver), and/or one or more interfaces (such as a wired interface, e.g. to an internal network or to the internet, etc.). In some implementations, the input/output device 458 may be implemented by a network interface, which may possibly be implemented as a network interface card (NIC), and/or a computer port (e.g. a physical outlet to which a plug or cable connects), and/or a network socket, etc., depending upon the implementation.

The network device 452 and the UE 402 have the ability to implement one or more AI-enabled processes. In particular, in the embodiment in FIG. 5 the network device 452 and the UE 402 include ML modules 510 and 500, respectively. The ML module 510 is implemented by processor 210 of UE 402 and the ML module 500 is implemented by processor 454 of network device 452 and therefore the ML module 510 is shown as being within processor 210 and the ML module 500 is shown as being with processor 454 in FIG. 5. The ML modules 510 and 500 execute one or more AI/ML algorithms to perform one or more AI-enabled processes, e.g., AI-enabled link adaptation to optimize communication links between the network and the UE 402, for example.

The ML modules 510 and 500 may be implemented using an AI model. The term AI model may refer to a computer algorithm that is configured to accept defined input data and output defined inference data, in which parameters (e.g., weights) of the algorithm can be updated and optimized through training (e.g., using a training dataset, or using real-life collected data). An AI model may be implemented using one or more neural networks (e.g., including deep neural networks (DNN), recurrent neural networks (RNN), convolutional neural networks (CNN), and combinations thereof) and using various neural network architectures (e.g., autoencoders, generative adversarial networks, etc.). Various techniques may be used to train the AI model, in order to update and optimize its parameters. For example, backpropagation is a common technique for training a DNN, in which a loss function is calculated between the inference data generated by the DNN and some target output (e.g., ground-truth data). A gradient of the loss function is calculated with respect to the parameters of the DNN, and the calculated gradient is used (e.g., using a stochastic gradient descent (SGD) algorithm) to update the parameters with the goal of minimizing the loss function.

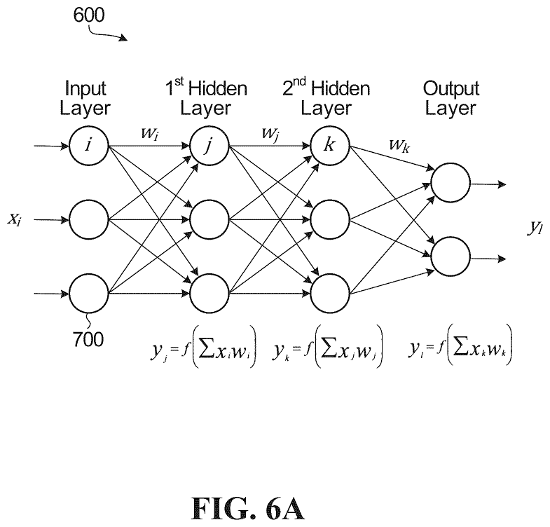

In some embodiments, an AI model encompasses neural networks, which are used in machine learning. A neural network is composed of a plurality of computational units (which may also be referred to as neurons), which are arranged in one or more layers. The process of receiving an input at an input layer and generating an output at an output layer may be referred to as forward propagation. In forward propagation, each layer receives an input (which may have any suitable data format, such as vector, matrix, or multidimensional array) and performs computations to generate an output (which may have different dimensions than the input). The computations performed by a layer typically involves applying (e.g., multiplying) the input by a set of weights (also referred to as coefficients). With the exception of the first layer of the neural network (i.e., the input layer), the input to each layer is the output of a previous layer. A neural network may include one or more layers between the first layer (i.e., input layer) and the last layer (i.e., output layer), which may be referred to as inner layers or hidden layers. For example, FIG. 6A depicts an example of a neural network 600 that includes an input layer, an output layer and two hidden layers. In this example, it can be seen that the output of each of the three neurons in the input layer of the neural network 600 is included in the input vector to each of the three neurons in the first hidden layer. Similarly, the output of each of the three neurons of the first hidden layer is included in an input vector to each of the three neurons in the second hidden layer and the output of each of the three neurons of the second hidden layer is included in an input vector to each of the two neurons in the output layer. As noted above, the fundamental computation unit in a neural network is the neuron, as shown at 650 in FIG. 6A. FIG. 6B illustrates an example of a neuron 650 that may be used as a building block for the neural network 600. As shown in FIG. 6B, in this example the neuron 650 takes a vector x as an input and performs a dot-product with an associated vector of weights w. The final output y of the neuron is the result of an activation function ƒ( ) on the dot product. Various neural networks may be designed with various architectures (e.g., various numbers of layers, with various functions being performed by each layer).

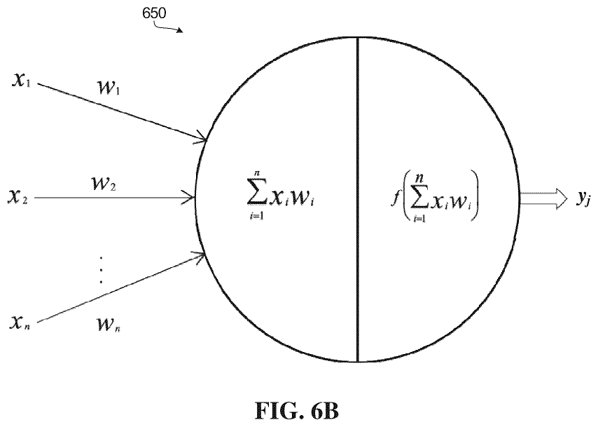

For example, an autoencoder (AE) is a type of neural network with a particular architecture that is suited for specific applications. Unlike a classification or regression-purposed neural network, in most conventional use-cases an AE is trained with the goal of reproducing its input vector x at the output vector \hat{x} with maximal accuracy. The caveat is that the AE has a hidden layer, called a latent space z, with a dimensionality less than that of the input layer. The latent space can be thought of as a compressed representation and the layers before and after the latent space are the encoder and decoder, respectively. In many cases, it is desirable to minimize the size of the latent space or dimensionality while maintaining the accuracy of the decoder. FIG. 7 illustrates an example of an AE 700 that includes an encoder 702, a latent space 704 and a decoder 706. In this example, the encoder 702 input has a dimensionality of 5, which is reduced to 3 at the latent space 704 and expanded again to 5 by the decoder 706.

A neural network is trained to optimize the parameters (e.g., weights) of the neural network. This optimization is performed in an automated manner and may be referred to as machine learning. Training of a neural network involves forward propagating an input data sample to generate an output value (also referred to as a predicted output value or inferred output value), and comparing the generated output value with a known or desired target value (e.g., a ground-truth value). A loss function is defined to quantitatively represent the difference between the generated output value and the target value, and the goal of training the neural network is to minimize the loss function. Backpropagation is an algorithm for training a neural network. Backpropagation is used to adjust (also referred to as update) a value of a parameter (e.g., a weight) in the neural network, so that the computed loss function becomes smaller. Backpropagation involves computing a gradient of the loss function with respect to the parameters to be optimized, and a gradient algorithm (e.g., gradient descent) is used to update the parameters to reduce the loss function. Backpropagation is performed iteratively, so that the loss function is converged or minimized over a number of iterations. After a training condition is satisfied (e.g., the loss function has converged, or a predefined number of training iterations have been performed), the neural network is considered to be trained. The trained neural network may be deployed (or executed) to generate inferred output data from input data. In some embodiments, training of a neural network may be ongoing even after a neural network has been deployed, such that the parameters of the neural network may be repeatedly updated with up-to-date training data.

Referring again to FIG. 5, in some embodiments the UE 402 and network device 452 may exchange information for the purposes of training. The information exchanged between the UE 402 and the network device 452 is implementation specific, and it might not have a meaning understandable to a human (e.g. it might be intermediary data produced during execution of a ML algorithm). It might also or instead be that the information exchanged is not predefined by a standard, e.g. bits may be exchanged, but the bits might not be associated with a predefined meaning. In some embodiments, the network device 452 may provide or indicate, to the UE 402, one or more parameters to be used in the ML module 510 implemented at the UE 402. As one example, the network device 452 may send or indicate updated neural network weights to be implemented in a neural network executed by the ML module 510 on the UE-side, in order to try to optimize one or more aspects of modulation and/or coding used for communication between the UE 402 and a T-TRP or NT-TRP.

In some embodiments, the UE 402 may implement AI itself, e.g. perform learning, whereas in other embodiments the UE 402 may not perform learning itself but may be able to operate in conjunction with an AI implementation on the network side, e.g. by receiving configurations from the network for an AI model (such as a neural network or other ML algorithm) implemented by the ML module 510, and/or by assisting other devices (such as a network device or other AI capable UE) to train an AI model (such as a neural network or other ML algorithm) by providing requested measurement results or observations. For example, in some embodiments, UE 402 itself may not implement learning or training, but the UE 402 may receive trained configuration information for an ML model determined by the network device 452 and execute the model.

Although the example in FIG. 5 assumes AI/ML capability on the network side, it might be the case that the network does not itself perform training/learning, and instead a UE may perform learning/training itself, possibly with dedicated training signals sent from the network. In other embodiments, end-to-end (E2E) learning may be implemented by the UE and the network device 452.

### Scheduling

As the number and density of wireless communication devices have increased, it has become increasingly challenging to support good quality wireless communications using conventional wireless systems.

Machine-to-machine (M2M) communications may be one type of high density wireless communications. M2M communications is a technology that realizes a network for collecting information from devices (e.g., sensors, smart meters, Internet of Things (IoT) devices, and/or other low-end devices) that are typically massively and densely deployed, and for transmitting information captured by those devices to other applications in the network. M2M networks may be wired or wireless and may have a relatively large geographical distribution (e.g., across a country or across the world). M2M communications typically do not involve direct human intervention for information collection.

5G New Radio (NR) systems include features to support massive machine type communications (mMTC) that connects large numbers (e.g., millions or billions) of IoT equipment by a wireless system. It is expected in the near future that the amount of M2M communications conducted over-the-air will bypass those of human-related communications. For example, it is expected that 6G systems will connect more IoT devices than mobile phones. In 6G, a high-density IoT deployment is expected to give birth to many innovative applications, thereby profoundly reshaping many industries and societies. Some predictions expect that the deployment density in 6G systems may reach 109 IoT devices per 1 km². It would present a challenge for 6G systems to support such a high-density IoT deployment in which thousands or tens of thousands of IoT devices could potentially transmit their data back to the network simultaneously through shared radio channels.

Using AI, e.g. by implementing an AI model as described above, various processes, such as transmission scheduling, may be AI-enabled. Some examples of possible AI/ML training processes and over the air information exchange procedures between devices to facilitate AI-enabled scheduling for large numbers of densely deployed IoT devices in accordance with embodiments of the present disclosure are described below.

### Proportional-Fairness

As discussed previously with reference to FIG. 3, a network scheduler, such as the scheduler 253 shown in FIG. 3, is generally charged with allocating radio resource among all its associated terminals or devices. Over the past 20 years, scheduling algorithms based on proportional-fairness (PF) have become the industry standard and most currently deployed schedulers utilize a PF-based scheduling algorithm or some derivative thereof.

A PF-based scheduler aims to maintain an absolute fairness among all the devices by allocating a device a portion of a radio resource proportional to its relative request. For instance, suppose that 100 active devices request a radio resource simultaneously. If a device-A requests 5% of the total, a PF-based scheduler would typically allocate 5% of the radio resource to that device. Classic information theory proves that PF is a maximum-likelihood (ML) criteria optimization, which in theory is the best, and is one of the reasons that the PF algorithm has been the baseline scheduling algorithm for many years.

However, high-density IoT deployments, and the completely novel applications that are potentially associated with such deployments, will challenge the PF algorithm by challenging the assumption that the request of each device is independent and equally important. That assumption is generally true for mobile devices, such as smart phones or tablets, that can typically be considered as being independent. The PF algorithm prohibits the network from discriminating against any mobile device by executing a proportional fairness among them, which gives rise to a system gain. To illustrate this, consider simultaneous requests from a number of mobile devices as a multi-dimensional request distribution and take a measure of the distribution's entropy. According to information theory, the more heterogeneous the distribution is, the lower entropy it has, and the more system-gain headroom a PF scheduler could achieve.

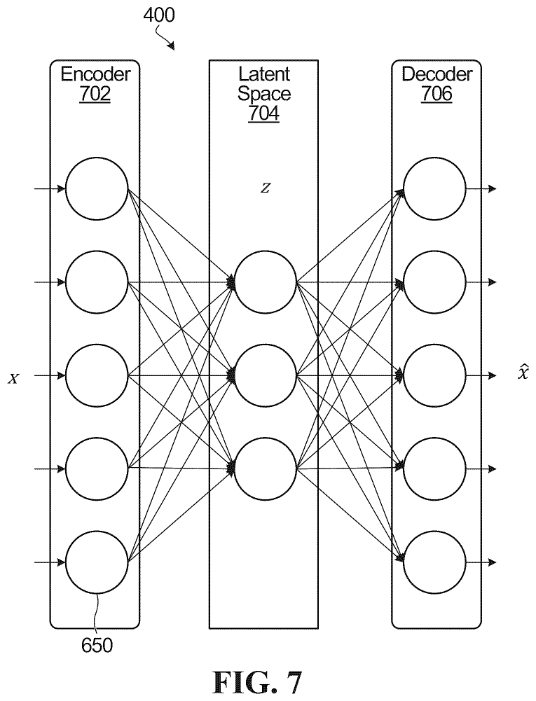

For example, FIG. 8 illustrates an entropy of a 2-dimensional (2-device) request distribution for two devices, namely device-A and device B. In the case of a heterogeneous distribution of requests between device-A and device-B, such as 80% and 20%, (e.g., say device-A is playing video and device-B is messaging), a PF-based scheduler could bring about a significant system-gain, as illustrated in the example on the left in FIG. 8. In contrast, in the case of a generally homogeneous distribution of requests, such as 45% and 55%, (e.g., say both devices are downloading music), a PF-based scheduler would only realize a small system-gain.

### High-Entropy IoT Request Distribution

Next, we consider what a typical multiple-request distribution is likely to be for an IoT deployment. In some typical IoT scenarios, a number of IoT devices will be measuring or observing a common object, phenomena, environment, target, or event from different perspectives, angles, formats or types. Because every device believes itself to be as informative as any other device, the resultant entropy of the multiple-request distribution is likely too high for a PF-based scheduler to provide any significant system-gain.

### Informative

Unlike mobile devices, IoT devices are generally not equally informative to each other for a downstream task. For example, in measuring or observing a common object, some devices with more advantageous positions may be more informative than others for a downstream task that is based on information about the object. Similarly, some devices with more disadvantageous positions may be completely irrelevant to the downstream task and some with similar positions may be redundant to each other. Ideally, when scheduling devices to obtain data for a downstream task, a scheduler would avoid scheduling those devices that are irrelevant and redundant devices in favor of preferentially scheduling the devices that are capable of providing informative data for the downstream task. However, this is not achievable with a conventional PF scheduler.

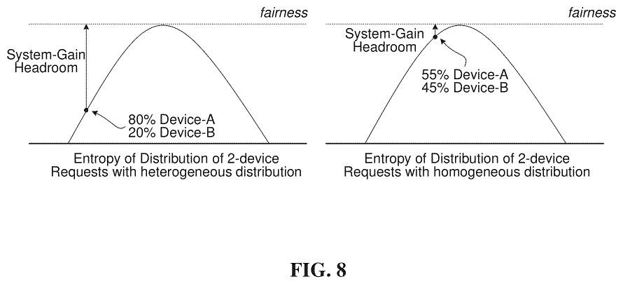

For example, FIG. 9 illustrates an example scenario in which multiple devices 900 are deployed and could potentially be scheduled to transmit information about measurements or observations of objects or phenomena within an area of observation 902. In this example, a downstream task may be related to detecting an object in the area of observation 902. As shown in FIG. 9, devices B, C, and D are informative for a task to detect a manifold “O” 904 in the area of observation 902. However, it can also be seen that device A is irrelevant to that task, and devices B and C are redundant to each other for the purposes of that task. If network device 452 were to utilize a PF-based scheduler to schedule uplink transmissions from the devices 900, it would equally partition the same radio resource among devices A, B, C, and D.

Contributiveness with Path Loss

A network device's environment (terrains, hills, buildings, woods, etc.) can cause a wide diversity of path-losses among its associated IoT devices. For example, it is possible that a more informative device may suffer from more severe path losses than a less informative device. In such a scenario, though very informative, the device would be of no use if its uplink signal cannot be successfully received by the network. As such, it must be kept in mind that, in wireless communication, being informative does not necessarily mean contributive. In other words, although the information collected by a deployed device may be informative, if the device is incapable of successfully communicating that information to the network, then it would not be contributive to a downstream task that is dependent on such information. In such scenarios, it may be more worthwhile to schedule less informative devices suffering from less path loss than very informative devices experiencing heavy path losses.

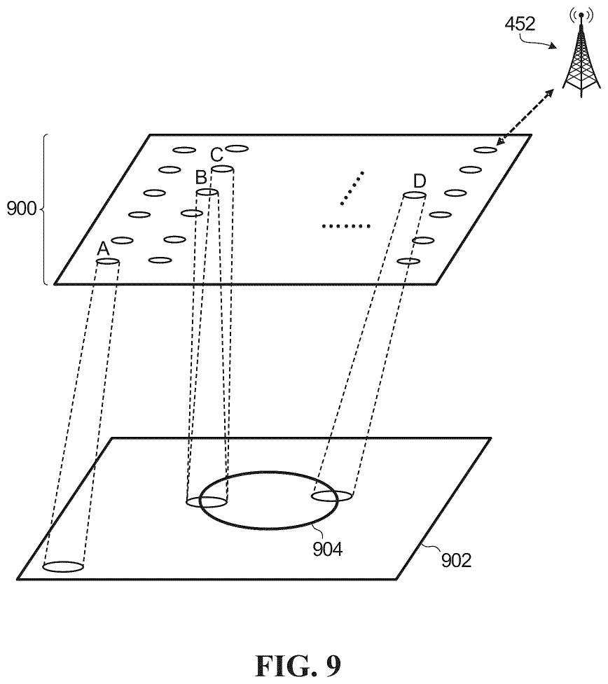

For example, FIG. 10 illustrates an example of the potential impact of unequal channel conditions in the IoT deployment scenario of FIG. 9 due to path losses caused by a hill 1000 in the surrounding environment of the network device 452. In particular, in this scenario, devices deployed between the network device 452 and the hill 1000 may be in an area 1002 in which they experience very low path losses but are uninformative to the downstream detection task. On the other hand, the device B, although informative, may not be contributive due to a deep shallow 1004 behind the hill 1000. In this scenario, rather than scheduling the informative but non-contributive device B, it may be better to schedule the redundant and less informative device C.

Contributiveness with Task

An aspect of the present disclosure introduces the concept of a contributiveness metric, which is a metric to compare two IoT devices. Classic information theory has difficulty to evaluate, score, or compare two sources, unless they are strictly in the same context. For a simple example, we can compare two sentences in English and even score how different (far) they are from each other, because both sentences use the same vocabulary and grammar (context). However, we may be unable to compare one English sentence and one Chinese sentence, even though they convey the same semantics, because English and Chinese have very different vocabulary and grammar (different contexts).

Contributiveness depends on a given downstream task; that is, how contributive the information that is provided by a source is for the entire fused information to be processed downstream for fulfilling a specific task. For example, imagine a scenario in which thousands of IoT devices are monitoring a wide forest and providing information based on their monitoring to the network. Their measurements may finally fuse to the network where some applications will process them to fulfill some tasks. For example, some tasks may classify the current forest state, some may reconstruct a real-time forest model in a virtual world, and some may alarm if a forest fire is detected. Different tasks form their own contexts to score the contributiveness of any source fused to the network. For instance, a temperature-meter IoT device that is considered as contributive for a forest-fire-alarm task may be of little use for a forest wildlife-population task. As results, a new task may require a new scheduling algorithm specific to scheduling devices for that task.

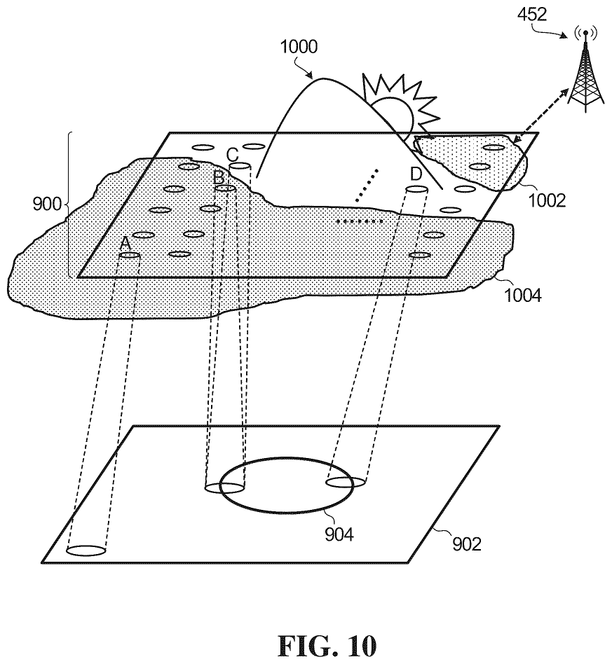

For example, referring FIG. 11A, it can be seen that a task related to classifying the “O” manifold 904 may need information from devices B, E, F, and D. On the other hand, with reference to FIG. 11B, it can be seen that only devices E and F may be needed for a task to detect the existence of a manifold 904.

### Incomplete Data

A data-driven method could potentially be used to identify the contributive devices for a downstream task with diverse path-loss channels. Ideally, the goal of such a method would be to accumulate a sufficient amount of raw data from all the IoT devices for a while in order to be able to determine which devices are contributive and which are not.

However, extreme high density and large number of IoT devices make it nearly impossible for a wireless system to accumulate a complete data set. This is partly due to the high cost of radio resources and partly due to stochastic hostile channels. Data packets from the devices that are subjected to heavy pass losses may be lost or not reach the network on time.

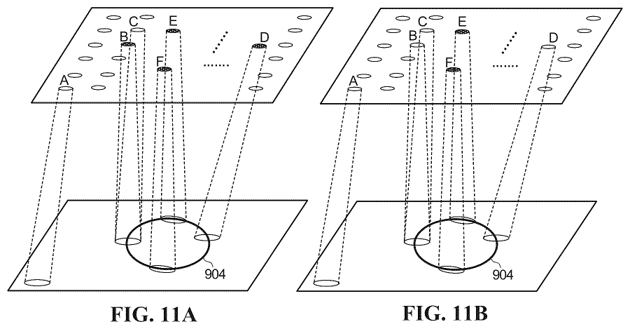

For example, FIG. 12 shown an example of the IoT deployment of FIG. 10 in which the devices G, H, I and J are currently experiencing high erasure channel conditions and thus are often incapable of successfully transmitting data to the network device 452. In this scenario, if the network device 452 randomly allocates uplink radio resources among some percentage, e.g., 80%, of the candidate devices for a given sample/measurement interval, some devices, such as devices G, H, I and J that are currently experiencing high packet loss rates, may not manage to successfully transmit their information back to the network even if they are allocated radio resources. In addition or instead, some devices may not be ready to transmit measurement information (e.g., due to measurement and/or processing limitations) when they are allocated radio resources.

As such, a robust scheduling algorithm should be able to determine the most contributive devices for a downstream task despite having an incomplete data set.

### PF-Based Scheduling is Unsuitable for IoT Deployments

The highly dense deployment of large numbers of IoT devices that is expected for 6G networks will pose several completely new challenges for wireless network schedulers. If a PF-based scheduler is adopted for these deployments, because each device has little idea of its contributiveness for a downstream task, each device considers itself to be as contributive as any other. Therefore, the resulting high entropy multiple-request distribution from the devices would cause a PF-based scheduler to partition the available radio resource equally into small fragments that it would allocate among all the requesting devices. In the end, as discussed above with reference to FIG. 8, the system-gain would diminish and the system would become less efficient.

### Sparsity of Phenomena

It is a fundamental truth that only a small number of laws dominate a rich physical surrounding, i.e. sparse laws produce abundant data. A sparsity is hidden beneath exuberant data of an object. A general learning is to associate a great amount of data to a task; whereas an efficient learning is to associate the data sparsity to the task.

In facing a large number of IoT devices, diverse path-losses over the channels, and a given task, it is desirable to have a scheduler that is capable of learning a few of the most contributive devices (or sensors) that can successfully provide sufficient information about the observed object to the processor fulfilling the task. If that is possible, it would be unnecessary for the scheduler to allocate the radio resource to all its associated IoT devices but, instead, could allocate the radio resource to the few devices that it has identified as being contributive to the task. This type of selective scheduling could significantly reduce or mitigate system overload.

### Contributiveness-Based Scheduling

Aspects of the present disclosure address several of the scheduling challenges that are expected in highly dense IoT deployments by providing methods of learning which devices are contributive for a given downstream task and scheduling based on their contributiveness.

Consider the following IoT scenarios:
A large number of IoT devices, terminals, or sensors (used interchangeably in the present disclosure) are connected to the network by radio channels.
These IoT devices are monitoring, measuring, observing, and collecting information about a common object, environment, target, or phenomena (used interchangeably in the present disclosure).
The network would schedule (allocate the radio resource for the transmissions of these measurements) as least IoT devices as possible for a given task in order to save radio resource. So, its scheduler would allocate minimum radio resource to most contributive IoT devices to transmit their measurements to the network that will fulfil a task by these transmitted measurements.
The path-losses, channel conditions, erasure rates, or packet loss rate (used interchangeably in the present disclosure) from the scheduled IoT devices to the network are not uniformly (diversely) random, i.e., some are subjected to more path loss (more hostile channel conditions) than others.
The received information from the scheduled IoT devices would fuse into a decoder or processor (used interchangeably in the present disclosure) of the network that would fulfill that specific downstream task, purpose, or objective (used interchangeably in the present disclosure).
Each IoT device, either scheduled or not, has little idea of how contributive it is to the downstream task. As such, each device continues to request the radio resource for its own measurement.
The scheduler of a network device sends scheduling messages or signaling (used interchangeably in the present disclosure) to the scheduled IoT devices and it can generally be assumed that there is no packet loss on the downlink channels from the network to these IoT devices.

Advantages provided by aspects of the present disclosure and/or problems that aspects of the present disclosure may solve or mitigate include:
A scheduler that allocates minimum resource to a small number of the IoT devices whose measurements are the most contributive to the downstream task.
In selecting these most contributive devices to the downstream task, the scheduler may take both their informativeness and their individual channel conditions into account. Optimization is done over the informativeness of the measurements and the packet loss rates of the channels from devices to the network (uplink). (Contributiveness=informative+packet loss rate)
The device selection is learned with an incomplete data set of the measurements.
In selecting the devices to schedule, the scheduler may also score and group the devices as a function of their contributiveness. Thereby, it may choose to schedule the most contributive group of the devices in a first batch. If the received information from this group does not sufficiently fulfill the task, the scheduler could continue to schedule a second group of the devices that were ranked as being less contributive than the devices in the first most contributive group. In this scenario, the received information from the two groups could then be combined to fulfill the downstream task in a diverse random channel distribution.

Although scheduling the most contributive devices seems like sampling, it is much more challenging and complicated than sampling. In a sampling problem, the most representative samples are typically kept for reconstruction. In a scheduling problem, the scheduler may need to fulfill an arbitrary downstream task more than a simple reconstruction task, preferably while using minimal radio resources, which implies two inseparable functions: a scheduler that selects the most contributive devices and a decoder that fuses and processes the received data for a given task.

In some embodiments of the present disclosure, a deep neural network (DNN) or autoencoder (AE) is used to train a scheduler that chooses and scores the most contributive IoT devices from all the candidate IoT devices and a decoder that fuses and processes the received information from the chosen (scheduled) devices. The scheduler is based on the first layer of the trained DNN, and the decoder is implemented by the subsequent layers of the DNN. The downstream task is defined into the training objective of this DNN. It can be either supervised with the labelled data or unsupervised without. The input training data consists of a number of samples. Each sample may contain the raw measurements from less than all of the candidate devices due to limited radio resource and to erasure channels.

In some aspects of the present disclosure, both selector and decoder are trained together in one DNN by an SGD (stochastic gradient descent) training algorithm. The backward propagation propagates the final training objective (task goal) backward to every neuron from the final layer to the first layer. As discussed in further detail below, the first layer corresponds to the scheduler/selector, while the rest of the layer(s) of the DNN correspond to the decoder. Accordingly, the first layer is a selector, which may be referred to as the scheduling layer that selects a subset of devices from a set of N candidate devices and transmits the information from the selected devices to the decoder. Each candidate device can be considered as an input dimension for the scheduling layer (selector), and only data from the selected devices may be output from this layer.

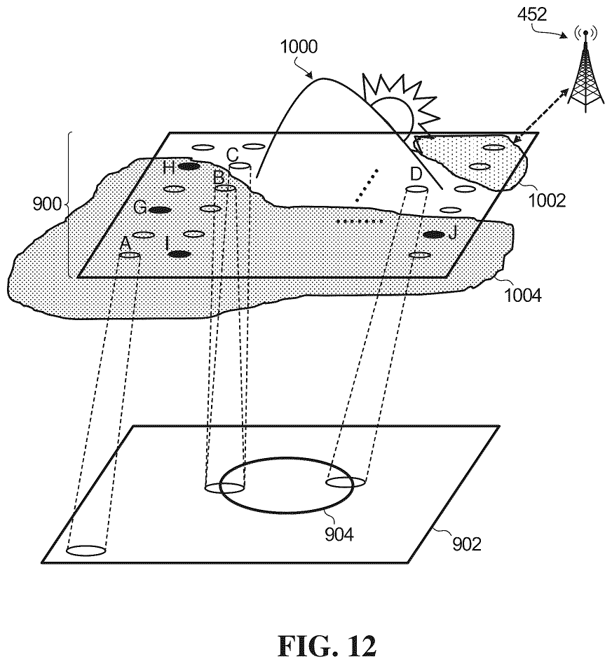

FIG. 13 illustrates an example of a DNN configured as an autoencoder 1100 that includes a first scheduling layer that functions as a scheduler 1102 and a number of decoding layers that function as a fuser and processor 1104 for the information received from the devices selected by the scheduling layer.

Unlike a convolutional layer or a max-pooling layer that compresses the dimensions from its input to its output by composing or combining several input dimensions into one output dimension non-linearly (by a non-linear activation function), the scheduling layer that implements the scheduler 1102 is linear and fully-connected such that each of its K output dimensions is a linear combination of all its N input dimensions. For example, as shown in FIG. 13, each of the K output dimension of the scheduling layer, i.e., yⱼ, j=1, 2, . . . , K, is the linear combination of the N inputs x₁, x₂, . . . , x_{N} respectively weighted by its N corresponding weights w_{1,j}, w_{2,j}, . . . , w_{N,j} such that:

$${y}_{j} = {\sum }_{i = 1}^{N} {w}_{i , j} \times {x}_{i} , i = 1 , 2 , … , N ; j = 1 , 2 , … , K$$

However, as discussed in further detail below, the training of the autoencoder 1100 may be carried out in a manner that forces the N weights or coefficients of the linear combination of each output dimension to be polarized such that only one input remains and the rest are eliminated; that is, the input with the weight approaching 1 survives and the rest with a weight approaching 0 dies.

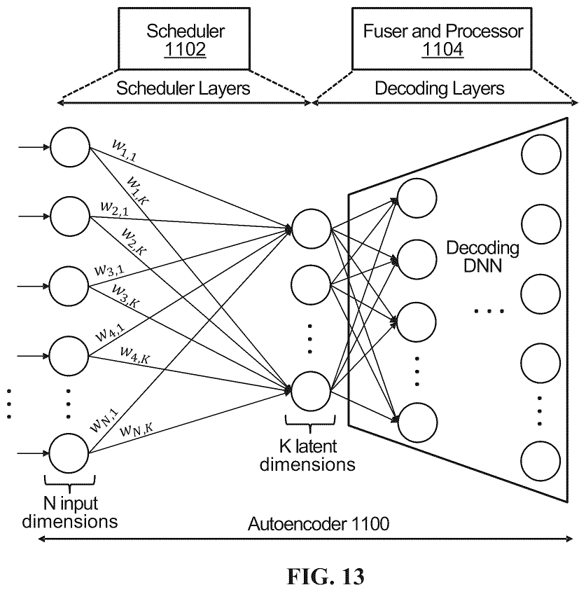

In some embodiments, the selection sparsity may be reinforced by a training hyper-parameter, referred to herein as temperature (or other names for the similar control), to reinforce a convergence to local minimum (polarization). For example, along with the training, the training temperature may be gradually cooled down so that only 1 among the N weights of the linear combination for an output dimension survives at the end of the training. FIG. 14 illustrates an example of epoch-by-epoch cooling during training, according to one embodiment. As shown in FIG. 14, all devices may be active during an initial training epoch and as the temperature parameter is cooled epoch-by-epoch the number of active devices decreases as less contributive devices are excluded or de-selected.

In practice, although many different cooling strategies can be taken, an exponential decay strategy has been used in the following examples discussed below. After the training is done, the first layer ends up with a selector that choose K devices from N candidates (although a given device may be selected for more than once among the K selected devices, as discussed in further detail below), and the rest of the layer(s) is/are used as the corresponding decoder that fuses and processes the information transmitted from the selected devices. Based on the trained selector, the scheduler would allocate the uplink radio resource and send the scheduling messages or signaling to the selected devices.

In preparing the training and test data set for this deep neural network, the network may collect the raw measurements from a set of N candidate device for several time intervals. However, it is practically difficult to obtain a complete training & test data set, i.e. every raw measurement from all the N devices, partly due to the high communication overhead required to do that and it associated cost and partly due to random packet loss over diverse channels. In reality, the network may, for example, allocate the radio resource allowing maximum 70% raw measurements of the N devices in each time interval. However, the network may collect less than 70% of the devices partly due to the random and diverse path loss distribution of the hostile channels. The packets from some devices may be more likely to be lost than others. Logically, the diverse packet-loss rate distribution would be embedded into the training & test data set. Since the deep neural network learns with this training data set, the selector of K devices from N would reflect the diverse packet-loss rate distribution.

In general, the number K of devices that are required is task-dependent, i.e., the number of selected devices depends on the downstream task. Intuitively, because a classification task is generally easier than a reconstruction task and a detection task is easier than a classification task, it is generally true that K_{reconstruction}>K_{classification}>K_{detection}. In practice, this solution can be left to the deep neural network itself. Over the scheduling (selector) layer, it is not forbidden for one input dimension to be connected to more than one output dimension. After the training, it is quite possible that more than two output dimensions come from the same input dimension (device). In other word, some devices are chosen for more than once. Given a specific task (reflected in the training objective for that deep neural network), the minimum number of devices, Kₘᵢₙ, that doesn't trigger any repeated selections can be determined. This Kₘᵢₙ value is regarded as the minimum number of the scheduled devices to fulfil the specific task by the training data set (embedded by the diverse distribution of the hostile channels.) Different tasks will generally have different Kₘᵢₙ.

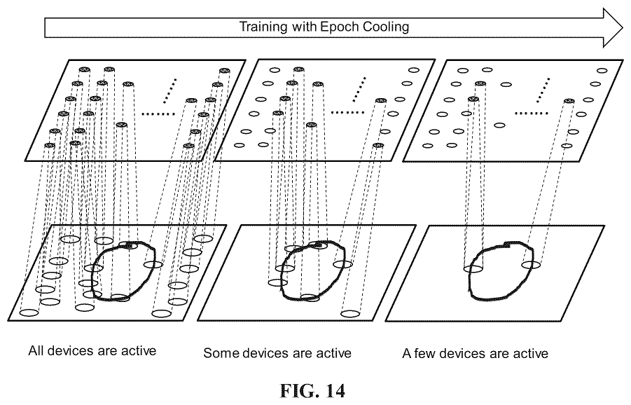

FIG. 15 illustrates an example of the repeated selection of contributive devices that can occur when the output dimension K of the scheduling layer is greater than Kₘᵢₙ for a given task. For example, as shown in FIG. 15, when the output dimension K is equal to Kₘᵢₙ, the training results in 4 non-repeated devices A, B, C and D being chosen by the scheduling layer. However, if the output dimension K is increased to K₁, where K₁>Kₘᵢₙ, the training again results in devices A, B, C and D being chosen but devices A and C are each chosen multiple times. Similarly, if the output dimension K is further increased to K₂, where K₂>K₁, devices A, B, C and D are again chosen but in this cases devices A, B and C are each chosen multiple times.

As shown in FIG. 15, when the network deliberately sets K>>Kₘᵢₙ to train the deep neural network, there may be some devices chosen repeatedly. The more time a device is chosen, the more contributive it is. Therefore, the network can score and cluster the chosen devices in function of how many times it is chosen given a task.

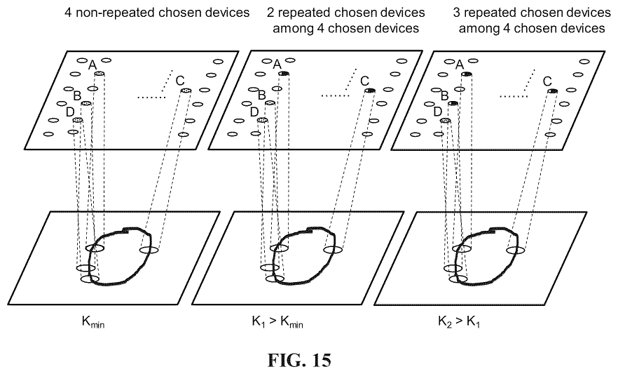

FIG. 16 illustrates an example of a scenario in which the output dimension K of the scheduling layer is much greater than Kₘᵢₙ and the ranking of contributive devices that can be done based on the number of times each contributive device is chosen by the scheduling layer. In this example, four devices A, B, C and D are chosen by the scheduling layer, but device A is chosen 4 times, devices B and C are each chosen 2 times, and device D is chosen only 1 time.

The training can result into several groups of devices in term of their contributiveness (times to be chosen) to the task. For example, based on being chosen by 4 output dimensions of the scheduling layer, device A may be ranked as more contributive than devices B and C, which were each chosen by 2 output dimensions. Similarly, device D, which was only chosen by 1 output dimension may be ranked as less contributive than devices B and C. The scheduler allocating the radio resource among all the chosen survival devices can allocate proportionally to their contributiveness rather than their requests. For example, it may allocate more bandwidth (lower coding rate, or higher transmission power) to the group that includes devices chosen by 4 output dimensions (e.g., device A) than the lower ranked group that includes devices chosen by 2 output dimensions (e.g., device B and device C).

If the network can cluster the chosen survival devices into the groups by their contributiveness to a task, the scheduler may take an opportunistic advantage to schedule the groups of the most contributive devices in a first group (K₁). If the information transmitted from the first batch of the devices provides the decoder a sufficient confidence, it is not necessary to schedule any further devices; otherwise, the scheduler may continue to schedule a secondary group of the less contributive devices (K₂).

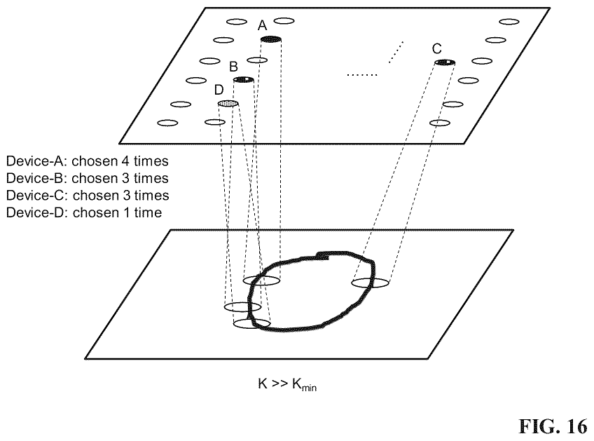

FIG. 17 illustrates an example in which contributive devices have been grouped based on their contributiveness rankings (based on the number of times they are chose by the scheduling layer) and the groups are then incrementally scheduled as needed in order to confidently fulfill the downstream task. In this example, the highest ranked group, which includes device A, is scheduled first, and the information received from device A is processed by the decoding DNN, as indicated at 1202 in FIG. 17. If the information received from device A enables the decoder to fulfill the downstream task with sufficient confidence, then the scheduler need not schedule any of the other groups. On the other hand, if the information from device A is insufficient, the scheduler may then schedule the second highest ranked group, which includes device B and device C. In this scenario, the information that was previously received from device A may be fused and processed with the newly received information from devices B and C by the decoding DNN, as indicated at 1204 in FIG. 17. If the information received from devices A, B and C enables the decoder to fulfill the downstream task with sufficient confidence, then the scheduler need not schedule the third highest ranked group, which includes device D. Otherwise, the scheduler may then schedule the third highest ranked group. In which case, the information that was previously received from devices A, B and C may be fused and processed with the newly received information from device D by the decoding DNN, as indicated at 1206 in FIG. 17.

The network prepares the training data set for a relatively large period. The diverse distribution of the hostile channels embedded into the training data set is usually at a large-scale due to high buildings, mountains, woods and so on. Some medium-scale randomness may not be fully represented. For example, a moving truck could block some line of sight (LoS) radio paths. To deal with the medium-scale channel randomness, the scheduler could make use of relaying nodes. For example, when the channel of a contributive device is subjected to a medium-scale hostility, the contributive device can pass its information to a less contributive device that is subjected to a less hostile channel in order to have the less contributive device relay the information to the network.

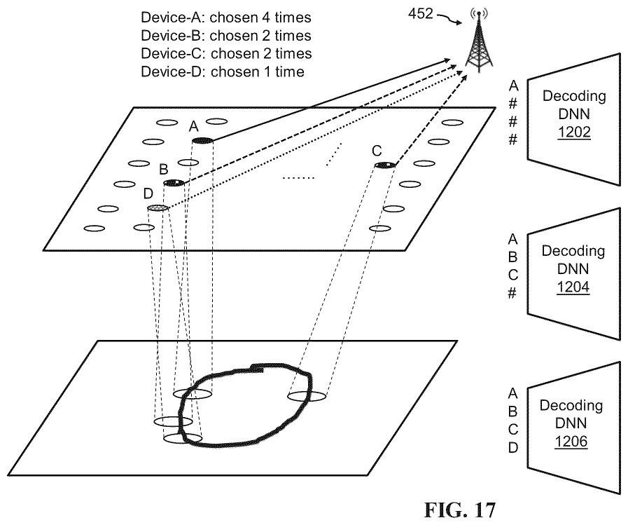

FIG. 18 illustrates an example of a less contributive device acting as a relay for a more contributive device experiencing poor channel conditions. In this example, the devices A and C have been identified as contributive to a downstream task related to object 904. On the other hand, device E is not in an advantageous position to observe the object 904, and thus has been determined to be non-contributive for that particular downstream task. At the moment depicted, devices A and E are experiencing favorable channel conditions that are allowing them to transmit information to network device 452 at acceptable packet loss rates, as indicated at 1300 and 1306, respectively. However, device C is currently experiencing hostile channel conditions such that it may be able to receive downlink transmissions from network device 452 but may be unable to successfully transmit uplink transmissions to network device 452, as indicated at 1302. In this scenario, network device 452 may instruct contributive device C to relay its information to less contributive device E, as indicated at 1304, and allocate uplink radio resources to device E to transmit the relayed information from device C to network device 452.

### Training & Test Data Set Preparation

In order to prepare a robust training & test data set, a network scheduler could potentially allocate the radio resource among all of the candidate devices over a period of time in order to sample as many raw measurements from all of the candidate devices as practically possible over that period of time. However, this is often impractical for several reasons. Firstly, it is generally too expensive in reality to allocate radio resource for all of the devices at the same time for a long period of time. Alternatively, the network scheduler could instead randomly sample a certain percentage of N devices, say 70% of them, in each sampling interval. Over a number of sampling intervals, the random sampling can cover all N devices. Secondly, some devices suffering from severely hostile channel conditions may not succeed in transmitting their measurements to the network, even if they are allocated a radio resource. Their information or package is erased or lost with certain probability, which may be referred to as an erasure rate or packet loss rate. Thirdly, some devices may spend too long to complete their physical measurement/observation. For example, even if allocated a radio resource for a given sampling interval, a device device's measurement data may not be ready for transmission yet. Therefore, each sample of training & test data set may not be a full-dimensional (N) one. The hostile channel condition (path losses) and measurement readiness of a device is embedded into the training & test data set. For example, although a device holding an advantageous position to measure an object may be very informative, its channel condition may be very bad (just in the shadow of a high building, for example), and therefore its information (packets) would not often appear in the training & test data set. As a result, the training may judge that device as being less contributive.

Depending on the downstream task, the sampled raw data can be labelled or grouped to form a final training & test data set. Now, the network can start to train the DNN for a scheduler to pick a subset of the K most contributive devices and for a decoder to fuse the received information of the scheduled K devices for the downstream task.

### Training

Referring again to FIG. 13, it is noted that the DNN or autoencoder 1100 consists of a scheduling or selector layer and several decoding layers. The scheduling layer is the first layer (linear and fully connected from N inputs to K outputs), while the decoding layers make up the rest of the layers. The decoding layers may include one or more fully-connected layers, one or more convolutional layers, one or more recurrent layers, with non-linear activation function, combinations of one or more of the foregoing types of layers and so on). As noted earlier, a hyper-parameter referred to as temperature tunes the polarization of the coefficients on the scheduling layer. Further details regarding polarization are discussed in the next section. Over this N-to-K linear and fully connected layer, each output is a linear weighted combination of all the N inputs.

The weights on the scheduling layer may be updated by SGD with a backpropagation algorithm, which means that the training objective (the downstream task) is taken into account by the polarizing of the scheduling layer.

The polarization is implemented with the intended training result being that only one of N weights will be very close to 1 and the other N−1 weights approach to 0 for any output. For example, w_{i,j} is the weight coefficient from the input xᵢ to the output yⱼ. If w_{i,j} is very close to 1, the input xᵢ gets selected for that output yⱼ; otherwise (w_{i,j} is very close to 0), the input xᵢ is not selected for that output yⱼ. It is possible that w_{i,j}=0 and w_{i,k}=1, which means that input xᵢ is not selected for that output yⱼ but is selected for output yₖ. It is also possible that w_{i,j}=1 and w_{i,k}=1, which means that input xᵢ is selected for both output yⱼ and output yₖ. In this latter scenario, the device i is chosen or selected twice.

As noted earlier, the number of times that an input is chosen indicates its contributiveness for the task. The network can score and group the K chosen devices by how many times each device is chosen on the scheduling layer.

The network generally has no idea which value for K is suitable for a specific downstream task. As aforementioned, different tasks may have different suitable Ks. The network can use a number of DNNs with different K in parallel but with the same training & test data set and the same training objective. By observing the appearance of a survival (scheduled) device being selected more than once by the scheduling layer, the network can determine the minimum number of the devices to be scheduled, Kₘᵢₙ, to fulfil the training objective.

Alternatively, the network can start with a large K value. In which cases there are likely to be many survival (scheduled) devices that are selected more than once by the scheduling layer. The scheduler may then schedule those devices that have been selected more than once, and may perform incremental group-based scheduling as discussed earlier.

### Scheduling

The close-to-1 weights on the scheduling layer indicate to the scheduler which K devices to be scheduled. The received information from the K devices can then fuse into the decoding layers to fulfil the task as DNN inference. The scheduling procedure corresponds to the inference of the trained DNN. Based on the close-to-1 weights on the scheduling layer, the network scheduler would allocate the uplink radio resource to these K (or less if some devices are chosen more than once by the scheduling layer) by sending control messages or signaling to those devices. The received information from the scheduled devices would be input to the decoder to be processed by the trained decoding layers.

In some cases, the K devices may be scored or ranked and grouped in terms of how many times they are each chosen on the scheduling layer. The devices or groups or clusters with the higher scores or ranks may be more contributive than those with lower scores or ranks. Based on the scores or ranks, the scheduler can allocate the radio resource proportionally. In some ways this can be viewed as a PF (proportional-fairness) over devices' contributiveness rather than devices' requests. For example, the total radio resource can be allocated among the different groups proportionally to their scores (contributiveness).

The received information from all scheduled devices would make a K-dimensional input vector to the decoding layers. If some devices are unsuccessful in transmitting their information to the network due to hostile channel conditions or unready measurements, the scheduler may either replace the previously received information from these unsuccessful devices or simply noise or fixed values. The devices chosen for more than once may have their information copied to several inputs of the decoder. Since a group with a higher score may be given a higher priority of the radio resource allocation, it may be more likely for their information to reach the network successfully.

As noted earlier, the network scheduler may choose to schedule the highest-score group as the primary batch, group, or cluster. If the received information from the first batch provides sufficient confidence for the decoding layers to fulfil the downstream task, it would be unnecessary to schedule the rest devices; otherwise, the scheduler may continue to schedule the second highest-score group so that the received information from the secondary group can fuse with the information from the primary group into the decoding layers to enhance the confidence of the result of the decoder. It is an opportunistic way in which the channel diversity and contributiveness diversity can be exploited.

Channels may be subjected to medium-scale varying. For example, a moving truck would cause some medium-scale changes on the channel conditions. As a result, it is possible that a very contributive or informative device during the training stage could suddenly suffer from a channel condition degradation during the scheduling (inference) stage. As discussed earlier, in some embodiments the scheduler could instruct or request this device to pass its measurement to the other device (e.g., a device that is less informative but has a good channel condition) and instruct or request the other device to act as a relaying node to relay the information from the first device to the network.

### Polarization on Scheduling Layer

The scheduling layer is a selector based on concrete random variables that are continuous distributions referred to as concrete distributions. A sample from a concrete random variable is:

$${w}_{i , j} = \frac{{e}^{( \frac{log ( {α}_{i , j} ) + {g}_{i , j}}{T} )}}{{\sum }_{n = 1}^{N} {e}^{( \frac{log ( {α}_{n , j} ) + {g}_{n , j}}{T} )}} , i = 1 , 2 , … , N ; j = 1 , 2 , … , K$$

where
w_{i,j} is the N-by-K coefficient matrix from the N-by-1 input (xᵢ) to the K-by-1 output (yⱼ);
g_{i,j} is the sample from a Gumbel distribution; and
T is the temperature hyper-parameter.

When T→0, output j, its concrete distribution (the j-th column of w_{i,j}) would smoothly approaches a N-by-1 discrete distribution outputting one-hot vector with w_{i,j}=1 with a probability

$$\frac{{α}_{i , j}}{{\sum }_{n = 1}^{N} {α}_{n , j}} .$$

The introduction of concrete distribution brings about three significant advantages:
A discrete distribution is not differentiable so that the SGD back-propagation cannot propagate toward the scheduling layer, whereas the concrete layer is mathematically differentiable.
The scheduling layer results in a selector. During inference (scheduling), the scheduling layer simply selects K from N inputs according to the close-to-1 weights or coefficients on the trained scheduling layer. Therefore, for the output yⱼ, instead of observing which element of the j-th column of w_{i,j} is closest to 1, the input with the maximum α_{i,j}, i=1, 2, . . . , N:

$${y}_{j} = {x}_{{\underbrace{arg max}}_{i} ( {α}_{i , j} )}$$

can be chosen. This is referred to as the re-parameterization trick. In fact, the backward propagation will tune α_{i,j} rather than w_{i,j} directly. w_{i,j} is computed in terms of α_{i,j}, g_{i,j}, and T (current temperature).
The degree of the locality is tuned by temperature T. At the beginning of the training, T can be initialized as high enough to allow all the inputs to have equal opportunity to be selected for one output. Along with the training, T can be decreased to allow only one of N inputs to be selected for this output. For instance, Tᵢₙᵢₜ=10 and T_{end}=0.01. It is noted that the concrete random distribution does not allow T=0 but infinitively close to 0.

During the training, T decreasing is referred to as cooling. There are many alternative ways to decrease it: linearly, exponentially decay, and so on. Since T decays exponentially in most historic annealing optimization, it has been used in the following experiments, but aspects of the present invention are in no way limited to this specific cooling technique. The temperature (T) for the current epoch is

$$T = {T}_{init} \cdot {( \frac{{T}_{end}}{{T}_{init}} )}^{\frac{{Epoch}_{index}}{{N}_{epoch}}}$$

where Tᵢₙᵢₜ is the initial temperature, T_{end} is the ending temperature, Epoch_{index} is the index of the current epoch, and N_{epoch} is the total number of epochs. Certainly, implementation can have different decreasing method or even look-up-table-based one.

### Experiments

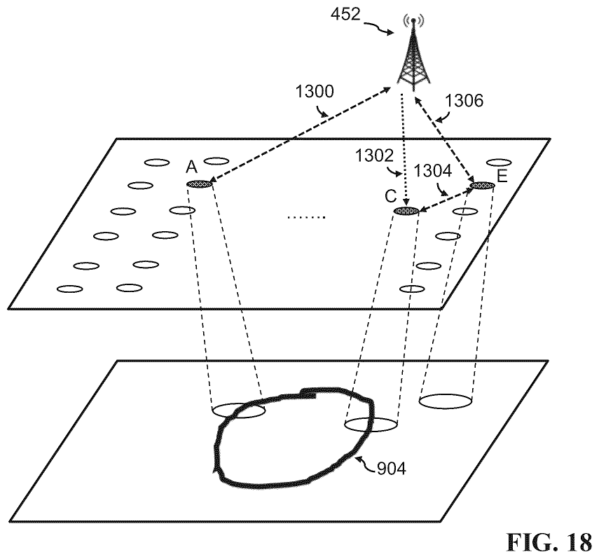

In the experiments discussed below, the Modified National Institute of Standards and Technology (MNIST) handwritten digit dataset has been used as an example to demonstrate the efficacy of the proposed scheduling techniques disclosed herein. Although MNIST is a 28-by-28 image, for the purposes of these experiments it is treated as a square region over which 784 IoT sensors are uniformly deployed in a 28-by-28 array. For example, FIG. 19 illustrates an example of such a uniform deployment of 784 sensors or devices in a 28×28 array to observe a region 1404.

Each sensor measures a small portion of the region, say one pixel, into 8 bits. Ideally, the total 784 sensors would transmit their measurements without error to the network at each time interval to fuse a 784-dimensional input measurement. An application decoder (fuser or processor) at the network device 452 or elsewhere on the network side fuses and processes this 784-dimensional input measurements for three different tasks: to classify the current state of the region corresponding to 10 digitals in MNIST, to reconstruct the global picture corresponding to reconstruction of 28-by-28 MNIST image, and to detect an abnormal state corresponding to the even-odd-digital separation (as if an even-digit is normal and an odd-digit is abnormal).

Unlike a traditional autoencoder for classification and reconstruction, a random erasure rate has been added in a uniform pattern on each sensor (equivalent to a pixel in MNIST) independently to mimic the packet-loss over the radio channels 1402 between the devices/sensors and the network device 452. Both training and inference (scheduling) would take place with these random erasure rates, which imitates what will happen when sensors are connected via path-loss wireless channels. In some of the later experiments discussed below, some random erasure rates have been added in some non-uniform patterns to imitate channel shadows.

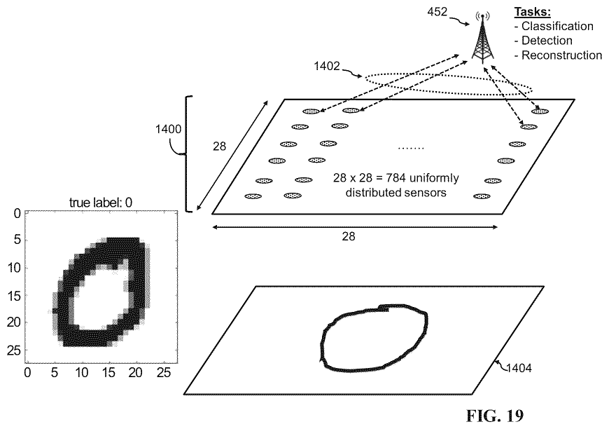

FIG. 20 illustrates the setup of the MNIST image input, the introduction of the erasure channel probability and the configuration of a concrete encoder of size K and the decoder that was used for the purposes of the following experiments. In particular, as shown in FIG. 20, the effect of a random erasure channel was introduced into the original MNIST image pixel data and the resulting 784 pixel image data inputs (N=784) were input to a concrete encoder 1500 of size K, which was varied as discussed in further detail below. The K outputs from the decoder 1500 were then fused and processed in a decoder 1502. The decoder 1502 could include various types of decoding layers, such as one or more fully-connected layers, one or more convolutional layers, one or more recurrent layers, with non-linear activation function, combinations of one or more of the foregoing types of layers and so on.

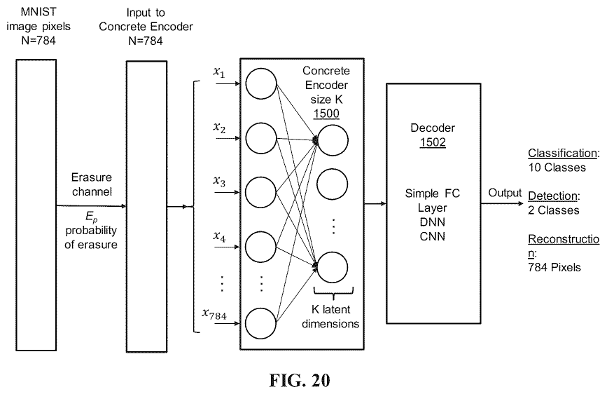

FIG. 21. illustrates a specific implementation of the decoder 1502 that was used for the purposes of the following experiments. In particular, the decoder 1502 shown in FIG. 21 includes a first convolutional layer 1602, a second convolutional layer 1604 and a fully connected layer of size 512 with a non-linear RelU activation function. The first convolutional layer 1602 includes 8 1-D filters and the second convolutional layer includes 16 1-D filters. It should be understood that this is merely one non-limiting example of a decoder structure.

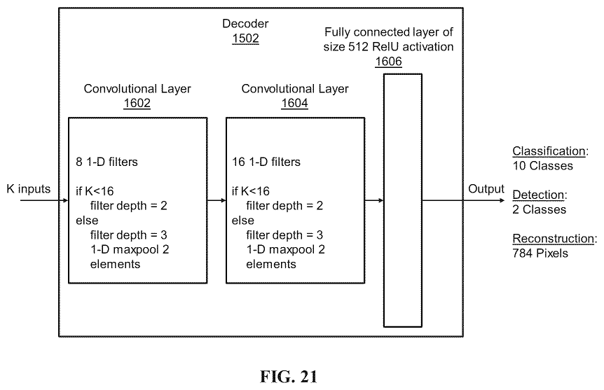

FIG. 22 shows the MNIST handwritten digit input images that were used in the following experiments.

### Example: Classification with Uniform Erasure Probability Eₚ

In this experiment, we will investigate and compare the performances of different numbers of the most contributive devices, K, and various erasure rates, Eₚ in a uniform pattern in which every sensor (pixel) is subjected to the same erasure rate independently. The task is to find the 10-MNIST digital classification by keeping K most contributive devices with various erasure channels from 0% to 90%.

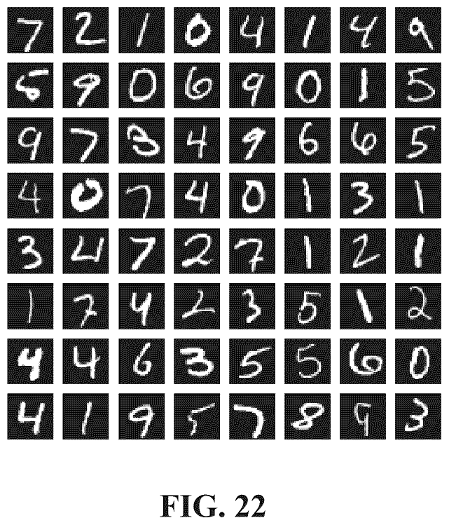

FIG. 23 shows a plot of the simulated accuracy percentages vs. erasure probability percentages for the 10-class classification task for different values of encoder size output K. From the simulation result, it is sufficiently good to keep 128 devices (sensors) from the total 784 (˜⅙) with an erasure probability up to 30%. It means that if every sensor had a 30% random packet loss rate over the radio channels, the scheduler could keep ⅙ of the sensors to complete the classification rather than all the devices without significant performance degradation. Furthermore, if every sensor suffered from a 60% random packet loss rate, the scheduler would have to keep 256 devices, about ⅓ of all the devices, to compensate for the channel degradation. If the channel continued to degrade, the performance of the classification would be damaged for whatever K would be.

### Example: Reconstruction with Uniform Erasure Probability Eₚ

In this experiment, we will investigate and compare the performances of different numbers of the most contributive devices, K, and various erasure channels, Eₚ. The task is to reconstruct the 28-by-28 MNIST image by keeping K most contributive devices with various erasure channels from 0% to 90%. To compare the performances, the reconstructed images would be input into a pre-trained classifier. The performance of the classification would indicate the performance of the reconstruction.

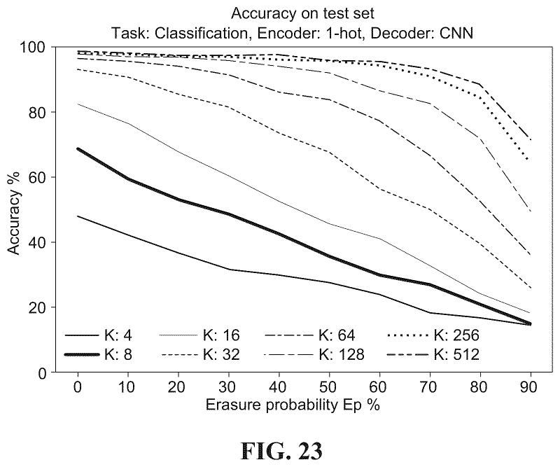

FIG. 24 shows reconstructed MNIST images with K=128/256 for different erasure probability percentages. For human eyes, the reconstructed images by (K=128 and Eₚ=30%) and (K=256 and Eₚ=30%) are very similar. We have to input them to the same classifier and measure their classification errors in order to compare the two.

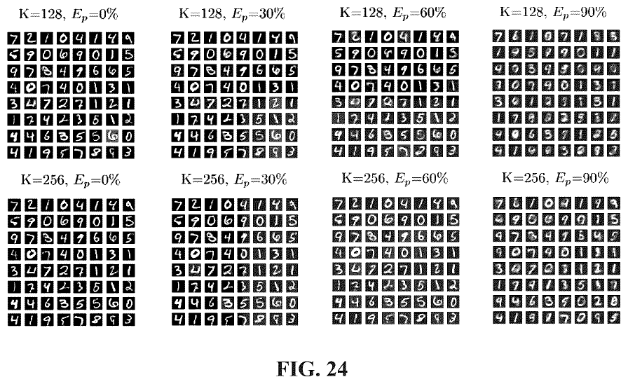

FIG. 25 shows a plot of simulated accuracy percentages vs. erasure probability percentages for a reconstruction task for different values of encoder size output K. From the simulation result, it is sufficiently good to keep 128 devices (sensors) from the total 784 (˜⅙) with an erasure probability up to 30%. It means that with 30% uniform erasure probability over the radio channels, the scheduler can keep ⅙ of sensors to complete the reconstruction rather than all devices. Furthermore, if the channels become worse to 60%, the scheduler would have to keep 256 devices, about ⅓ of the devices, to compensate for the channel degradation. If the channel continued to degrade, the performance of the reconstruction would get damaged for whatever K would be.

### Example: Detection with Uniform Erasure Probability Eₚ

In this experiment, we will investigate and compare the performances of different numbers of the most contributive devices, K, and various erasure channels, Eₚ. The task is to detect even-odd digitals by keeping K most contributive devices with various erasure channels from 0% to 90%.

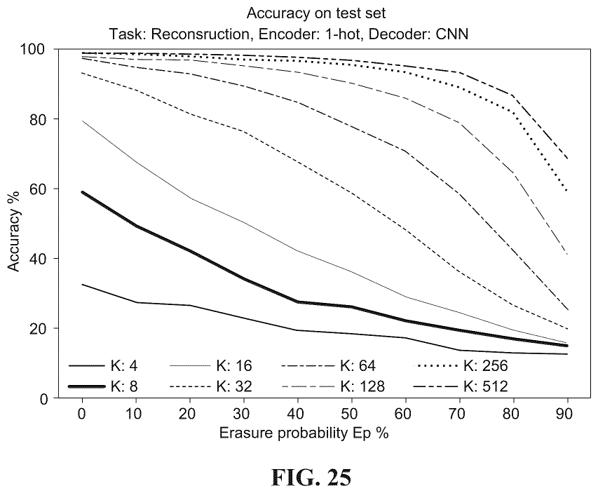

FIG. 26 shows a plot of simulated accuracy percentages vs. erasure probability percentages for a detection task for different values of encoder size output K. From the simulation result, it is sufficiently good to keep 64 devices (sensors) from the total 784 (˜ 1/12) with an erasure probability up to 30%. It means that with 30% uniform erasure probability over the radio channels, the scheduler can keep 1/12 of sensors to complete the detection rather than all devices. Furthermore, if the channels become worse to 60%, the scheduler would have to keep 128 devices, about ⅙ of the devices, to compensate for the channel degradation. If the channel continued to degrade to 80%, the scheduler would keep 256 devices (⅓) against the channel degradation.

More importantly, the experiment shows that the sparsity is task-dependent. The scheduler would keep much less devices for detection than for classification/reconstruction.

### Example: Minimum K for Classification Task with Eₚ=0

Supposing that there's no erasure (packet loss) on wireless transmission, we can investigate the minimum number of the contributive devices to be kept (sparsity to be needed) for a task of the classification. As we mentioned previously, some devices (or pixels) would be chosen for multiple times. Then, Kₘᵢₙ is defined as the number of the contributive devices to be kept to avoid multiple-time selection.

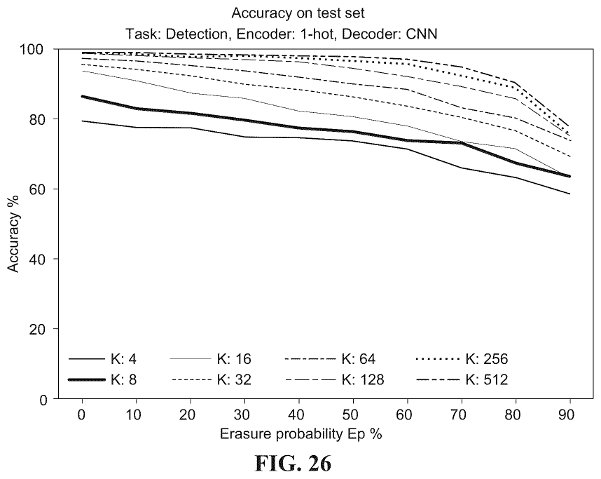

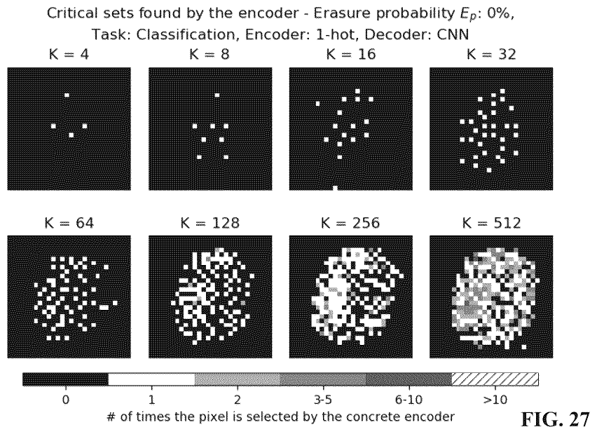

FIG. 27 shows the selected sets of devices in the 28×28 array for different values of encoder size output K and a 0% erasure probability percentage for a classification task. As shown in FIG. 27, the repeated selection (7-9 devices are chosen for more than once) appears when K is 128 with Eₚ=0. It means the Kₘᵢₙ for this classification task would be close to 128 in a perfect channel condition. It also means that no classification gain would be further obtained if more than 128 devices are chosen (with Eₚ=0). In the ideal transmission case (Eₚ=0), the sparsity related to this classification task is ⅙.

Certainly, if the transmission is not ideal with certain non-zero erasure rate, then Kₘᵢₙ would increase to compensate for the lost packages over the radio channels. For example in 28, which shows the selected sets of devices in the 28×28 array for different values of encoder size output K and a 50% erasure probability percentage for the classification task, when Eₚ=50%, Kₘᵢₙ increases from 128 to 256 to compensate against the package loss.

### Example: Minimum K for Reconstruction Task with Eₚ=0

Supposing that there's no erasure on wireless transmission, we can investigate the minimum number of the contributive devices to be kept (sparsity to be needed) for a task of the reconstruction. As we mentioned previously, some devices (or pixels) would be chosen for multiple times. Then, Kₘᵢₙ is defined as the number of the contributive devices to be kept to avoid multiple-time selection.

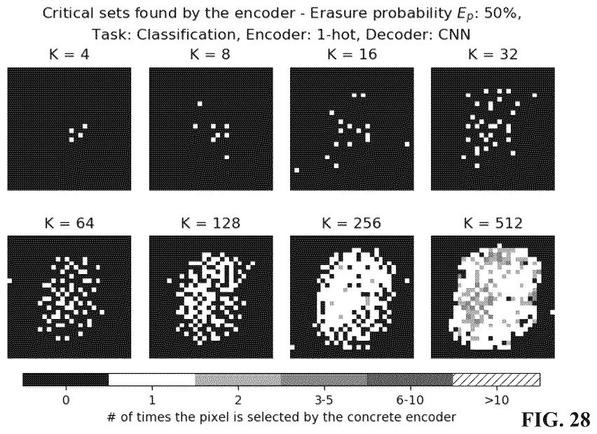

FIG. 29 shows the selected sets of devices in the 28×28 array for different values of encoder size output K and a 0% erasure probability percentage for a reconstruction task. As shown in FIG. 29, the repeated selection (1 device is chosen for more than once) appears when K is 256 with Eₚ=0. It means the Kₘᵢₙ for this reconstruction task would be close to 256. It also means that no reconstruction gain would be further obtained if more than 256 devices are chosen (with Eₚ=0). In the ideal transmission case (Eₚ=0), the sparsity related to this reconstruction task is ⅓. Compared with the Kₘᵢₙ=128 for classification task, the result proves again that sparsity is task dependent. Note that since their tasks of compressed sensing, lasso, and PCA are always reconstruction, the sparsity from which they take advantage may not be the smallest one for a task simpler than reconstruction.

### Example: Minimum K for Detection Task with Eₚ=0

Supposing that there's no erasure on wireless transmission, we can investigate the minimum number of the contributive devices to be kept (sparsity to be needed) for a task of the detection (even-odd separation). As we mentioned previously, some devices (or pixels) would be chosen for multiple times. Then, Kₘᵢₙ is defined as the number of the contributive devices to be kept to avoid multiple-time selection.

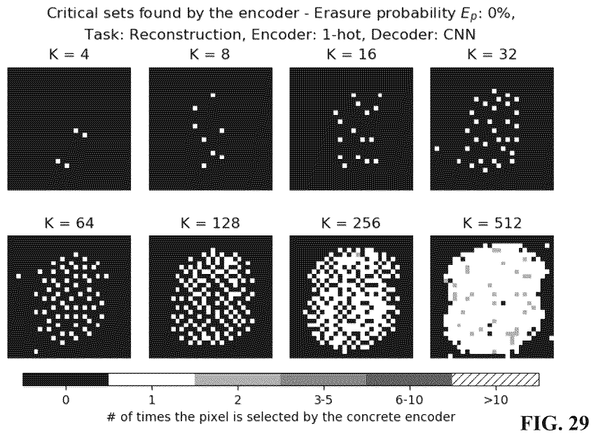

FIG. 30 shows the selected sets of devices in the 28×28 array for different values of encoder size output K and a 0% erasure probability percentage for a detection task. As shown in FIG. 30, the repeated selection (1 device is chosen for more than once) appears when K is 64 with Eₚ=0. It means the Kₘᵢₙ for this detection task would be close to 64. It also means that no detection gain would be further obtained if more than 64 devices are chosen (with Eₚ=0). In the ideal transmission case (Eₚ=0), the sparsity related to this reconstruction task is 1/12. Compared with the Kₘᵢₙ=128 for classification task and Kₘᵢₙ=256 for reconstruction task, the result proves again that sparsity is task dependent.

### Example: Classification Task Accuracy with Non-Uniform Eₚ

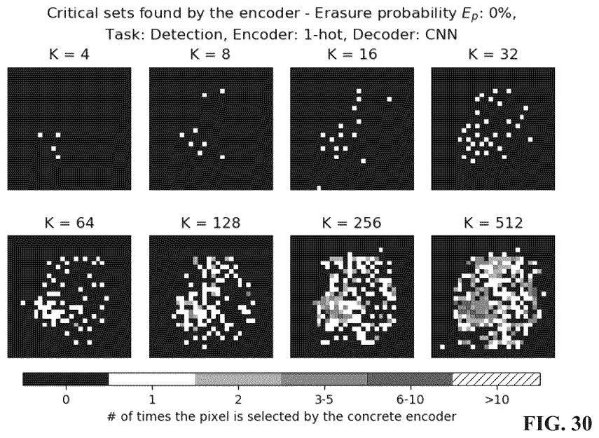

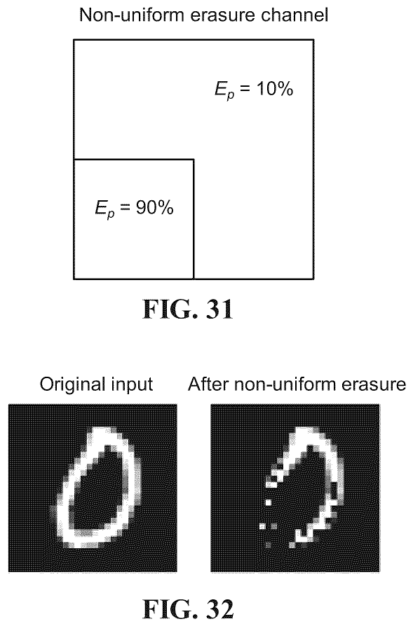

Non-uniform Eₚ is realized in situations where obstacles such as hostile terrains affect the erasure probability of a subset of the transmission channels of the sensors. The channel used in the experiments is depicted in FIG. 31, and the effect of this channel on the input can be seen in FIG. 32. This results into an overall average

$${E}_{p} = \frac{1}{4} \cdot 0.9 + \frac{3}{4} \cdot 0.1 = 30 \% .$$

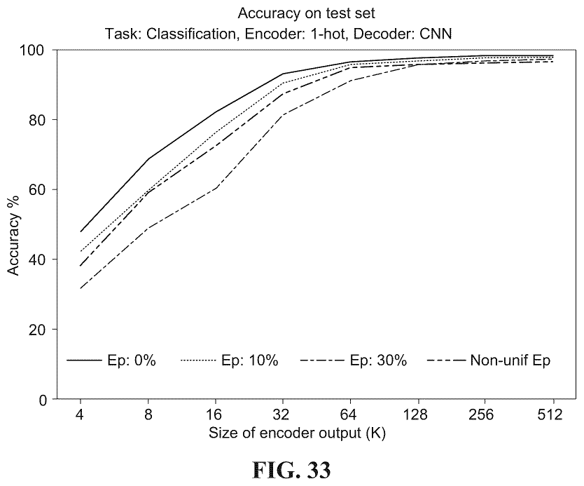

The accuracy for the classification task over this non-uniform Eₚ channel is compared against the accuracy over the channels with uniform Eₚ of 0%, 10%, and 30%, and the results are shown in FIG. 33.

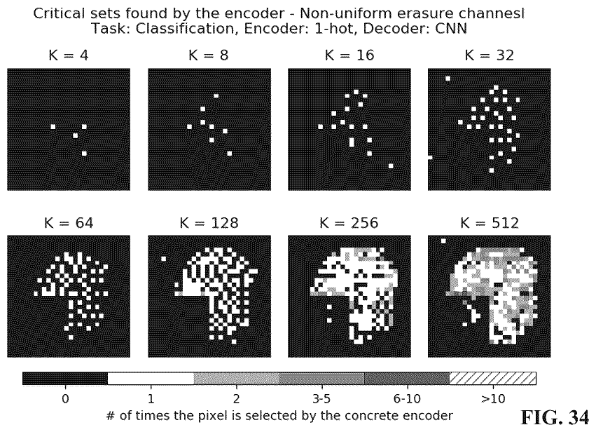

Results show that the accuracy over the non-uniform Eₚ channel (average 30%) is very similar to that over the uniform 10% Eₚ channel and much better than uniform 30% Eₚ channel, demonstrating that the scheduler is capable of learning to avoid the high Eₚ obstacle region while still maintaining the accuracy. This is further demonstrated by studying the pixel selection of the scheduler from FIG. 34, where it is seen that pixels from the high Eₚ region are avoided until high-redundancy scenarios. It is noted that the Kₘᵢₙ observed is close to 128, which is consistent with the Kₘᵢₙ observed for the channel with uniform Eₚ=0%.

### Example: Reconstruction Task Accuracy with Non-Uniform Eₚ

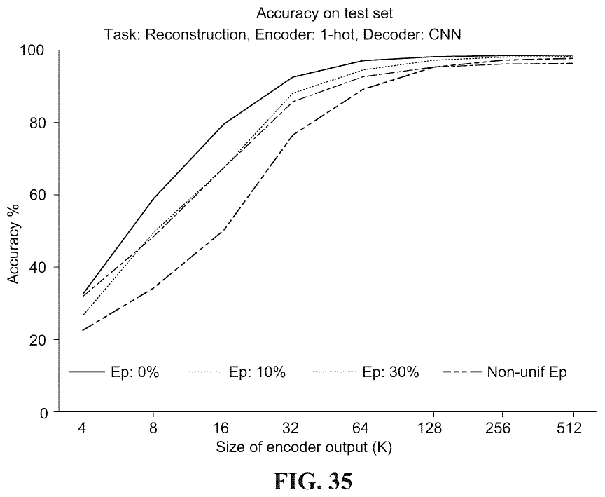

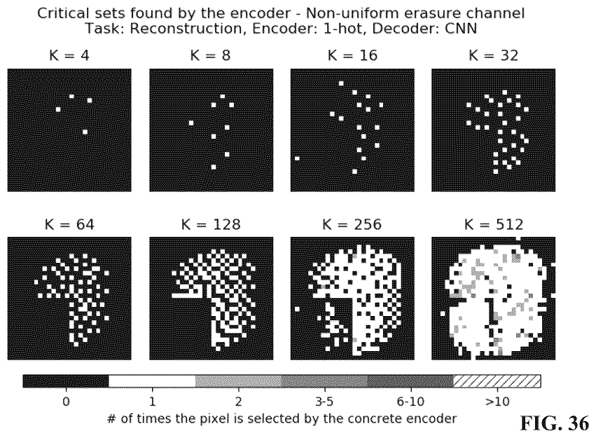

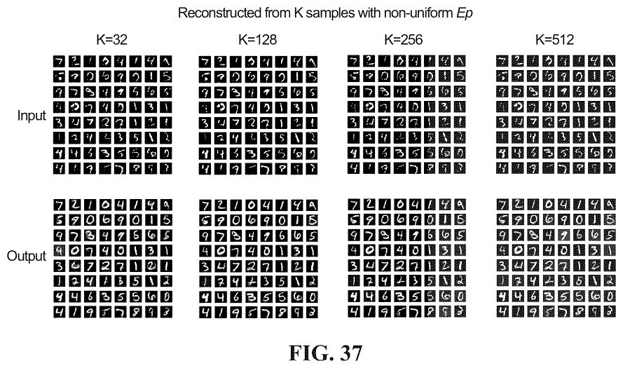

The accuracy for the reconstruction task over this non-uniform Eₚ channel is compared against the accuracy over the channels with uniform Eₚ of 0% and 10%, and the results are shown in FIG. 35. In addition, FIG. 36 shows the selected sets of devices in the 28×28 array for different values of encoder size output K over the non-uniform erasure channel shown in FIG. 31 for the reconstruction task. FIG. 37 shows the reconstructed MNIST images with K=32/128/256/512 over the non-uniform erasure channel shown in FIG. 31.

As in the classification task, results show that the reconstruction task accuracy over the non-uniform Eₚ channel is very similar to that over the uniform 10% Eₚ channel and much better than the uniform 30% Eₚ channel, demonstrating that the scheduler is capable of learning to avoid the high Eₚ obstacle region while still maintaining the accuracy. This is again further demonstrated by studying the pixel selection of the scheduler from FIG. 36, where it is seen that pixels from the high Eₚ region are avoided until high-redundancy scenarios. It is noted that the Kₘᵢₙ observed is close to 256, which is consistent with the Kₘᵢₙ observed for the channel with uniform Eₚ=0%.

### Example: Detection Task Accuracy with Non-Uniform Eₚ

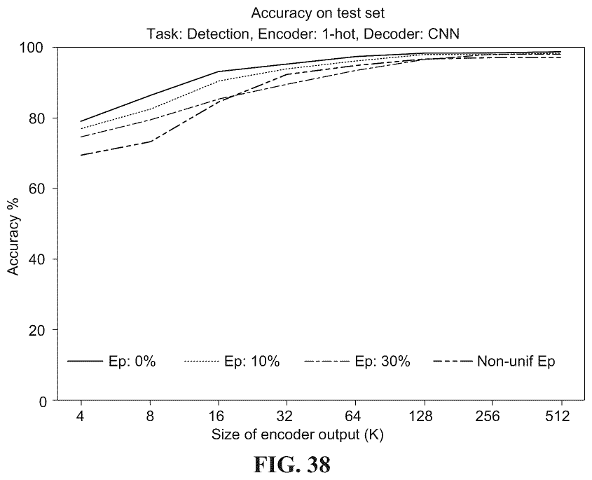

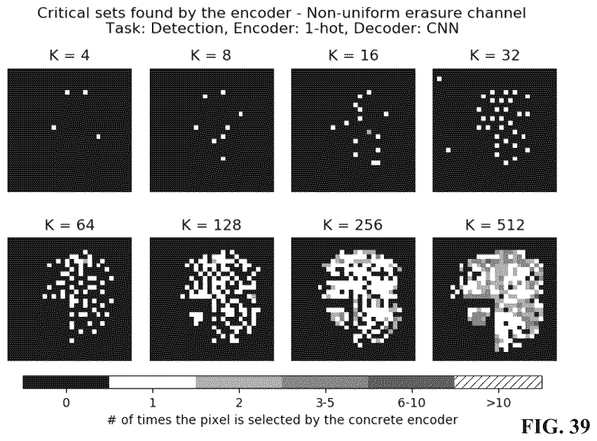

The accuracy for the detection task over this non-uniform Eₚ channel is compared against the accuracy over the channels with uniform Eₚ of 0% and 10%, and the results are shown in FIG. 38. In addition, FIG. 39 shows the selected sets of devices in the 28×28 array for different values of encoder size output K over the non-uniform erasure channel shown in FIG. 31 for the detection task.

Results show that the detection accuracy over the non-uniform Eₚ channel is very similar to that over the uniform 10% Eₚ channel and better than 30% Eₚ channel, except when K<32, in which case accuracy is slightly impacted. The results demonstrate that the scheduler is capable of learning to avoid the high Eₚ obstacle region while still maintaining the accuracy.

This is again further demonstrated by studying the pixel selection of the scheduler from FIG. 39, where it is seen that pixels from the high Eₚ region are avoided until high-redundancy scenarios. It is noted that the Kₘᵢₙ observed is close to 64, which is consistent with the Kₘᵢₙ observed for the channel with uniform Eₚ=0%.

### Example: Classification Task, Designing the Scheduler to Support Repeated Incremental Transmissions

The aim is to realize a HARQ-like scheme in which the scheduler first transmits a small number of critical samples, and then transmits more samples if some decision metric fails to meet a threshold.

ranging from 4 to 512, and in each case, the training of the scheduler is constrained to ensure that:

$${K}_{a} ⊂ {K}_{b} , 4 \leq a < b \leq 512$$

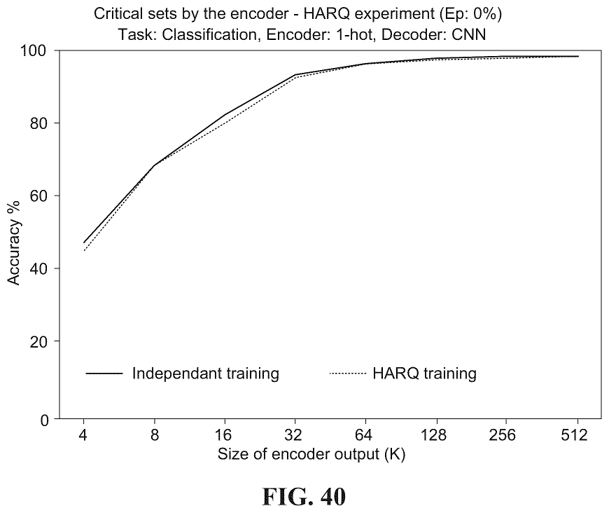

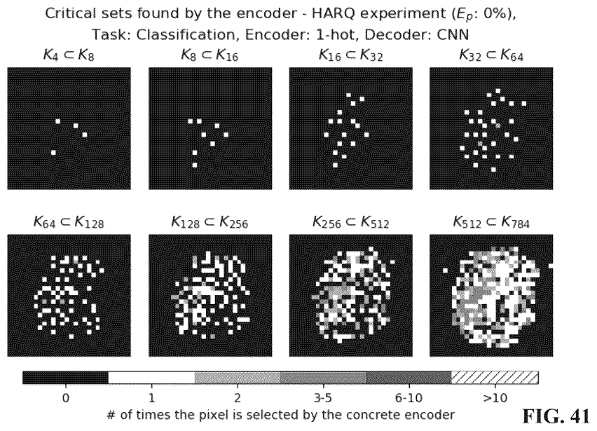

The for each Kₙ, where n∈{4, . . . , 512}, a new decoder is trained on the desired task. The accuracy for the classification task using this “HARQ training” is compared against the accuracy when using the “Independent training” method so far, over the channel with uniform Eₚ of 0%, and the results are shown in FIG. 40. In addition, FIG. 41 shows the selected sets of devices in the 28×28 array for different values of encoder size output K and a 0% erasure probability percentage with HARQ training for the classification task.

Results show that the accuracy obtained via HARQ training and Independent training are very similar, demonstrating that the scheduler is capable of learning the critical sets in an incremental fashion, while still maintaining the accuracy. The pixel selection of the scheduler from FIG. 41 demonstrates that the critical sets satisfy the HARQ condition:

$${K}_{a} ⊂ {K}_{b} , 4 \leq a < b \leq 512$$

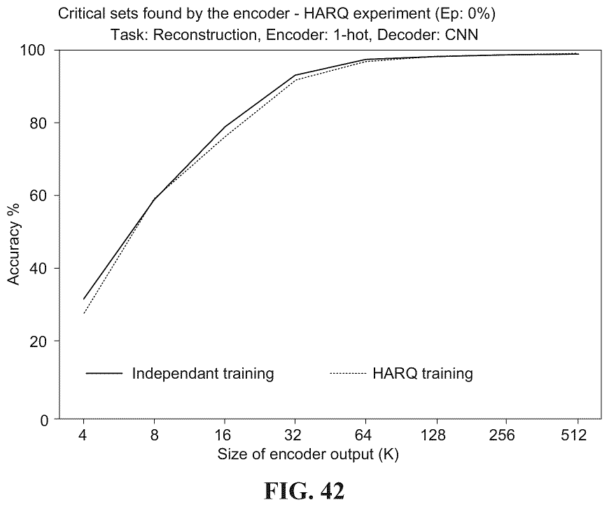

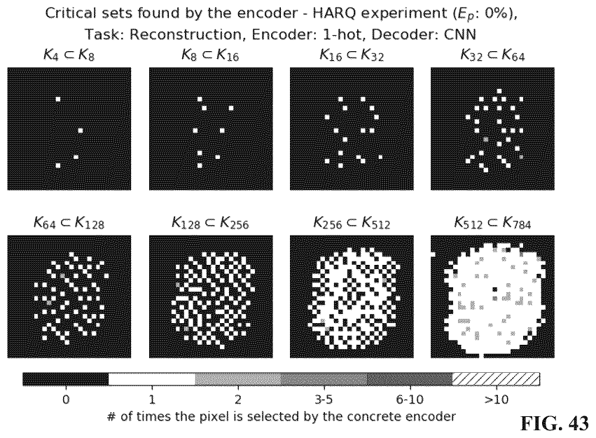

The accuracy for the reconstruction task using this “HARQ training” is compared against the accuracy when using the “Independent training” method so far, over the channel with uniform Eₚ of 0%, and the results are shown in FIG. 42. FIG. 43 shows the selected sets of devices in the 28×28 array for different values of encoder size output K and a 0% erasure probability percentage with HARQ training for the reconstruction task

demonstrating that the scheduler is capable of learning the critical sets in an incremental fashion, while still maintaining the accuracy. The pixel selection of the scheduler from FIG. 43 demonstrates that the critical sets satisfy the HARQ condition.

### Example: Detection Task, Designing the Scheduler to Support Repeated Incremental Transmissions

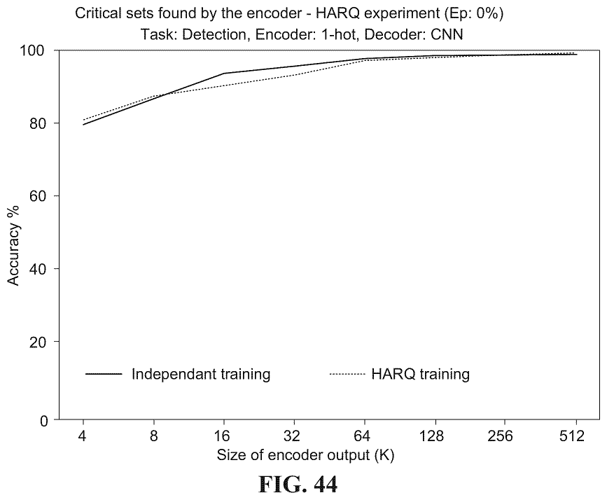

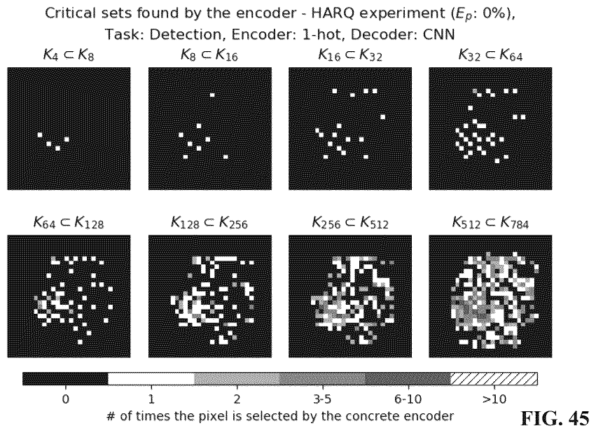

The accuracy for the detection task using this “HARQ training” is compared against the accuracy when using the “Independent training” method so far, over the channel with uniform Eₚ of 0%, and the results are shown in FIG. 44. FIG. 45 shows the selected sets of devices in the 28×28 array for different values of encoder size output K and a 0% erasure probability percentage with HARQ training for the detection task.

Results show that the accuracy obtained via HARQ training and Independent training are very similar, demonstrating that the scheduler is capable of learning the critical sets in an incremental fashion, while still maintaining the accuracy. The pixel selection of the scheduler from FIG. 45 demonstrates that the critical sets satisfy the HARQ condition.

In a wireless system, a number of devices (terminals, device-equipment, and so on) are connected to the network by one or several base-stations (BTSs, eNodes, Access points, and so on). These devices are measuring, observing, and collecting the information of a natural phenomenon (objective, target and so on). The network has a scheduler to allocate the UL radio resource for these devices to transmit their measurements or observations back to the network.

The allocation UL (uplink) radio resource can be in terms of bandwidths, modulation coding schemes, packet sizes, transmission durations, or/and spreading codes etc. Basically, the more radio resource a device gets, the more likely it succeeds in transmitting its measurement to the network. The scheduling message is transmitted over the downlink channels, either control channels or dedicated data channels. As the BTSs can have much higher transmission power, we assume that the scheduling messages could reach the scheduled devices successfully in time.

However, due to the limit of the UL radio resource and to diverse (non-uniform) path losses among the devices, not every device is given the UL radio resource as it requests and not all the devices would manage to transmit their measurements to the network in time. Therefore, the scheduler must carefully select the devices and allocate them the UL radio resource at this transmission interval. Traditionally, the scheduler would adopt a PF algorithm that would neglect the different path losses among the devices and allocate a device the radio resource proportional to this device's request.

Very different from the traditional PF scheduler, the contributiveness based schedulers disclosed herein would schedule the devices (select the devices and allocate them the UL radio resources) in terms of their contributiveness to a downstream task at the network side. The contributiveness metric indicates not only how informative a device is for the task but also how well it transmits this measurement to the network.

Just aforementioned, a device has little idea of how contributive it is for the global task at the network. Therefore, it would assume itself to be as contributive as others. The assumption would result into such a homogeneous request distribution among the devices observing a common objective. Such a high entropy multiple-device request distribution brings about little system gain to a request-based PF scheduler.

Contributiveness-based scheduling would eliminate the least contributive devices either due to their disadvantageous observation positions or due to their severe path losses or both. It would be a waste to allocate the radio resources to these least contributive devices.

Moreover, in the contributiveness-based scheduling methods disclosed herein, the contributiveness is specific to a given downstream task. The contributiveness of a device may vary from one task to another. A device quite contributive for one task may find itself irrelevant for another task.

In fact, multiple tasks may be done parallel with a group of IoT devices. Each task would identify its associated contributive devices. Some devices may be contributive for more than one task; some devices may be contributive for one task only; and some devices may be contributive for none of the task.

The contributiveness of a device is learned with raw data set (training & test data set) and a specific task. The learning is conducted by an autoencoder that contains at least two layers. The first layer is a linear fully-connected layer as scheduling or selector layer; the rest of the layers can be linear, non-linear, convolutionary, etc., as decoding layers. The training objective of this autoencoder is related to a downstream task: classification, detection, reconstruction, expectation of a long-term reward of a reinforcement learning, and so on.

Before the training stage, the network will prepare the training and test data set. In most cases, the network would uniformly and randomly allocate the resource for certain percentage of the devices to transmit their raw measurements back to the network at one time interval. Due to the diverse packet-loss rates over the different devices to the BTS channels, some packets may not reach the network successfully or in time. These lost packets would be recorded into the training & test data set to reflect the current path-loss distribution among the devices. The network would collect the raw measurements over a sufficient number of the time intervals.

After a sufficient amount of the training & test data are collected, the network may train the autoencoder to learn one more of the following:
The most contributive devices for the task;
The minimum number of the devices Kₘᵢₙ to be scheduled for the task;
The clusters of the contributive devices in terms of their contributiveness.

As discussed earlier, the training may be based on the SGD backpropagation from the last layer to the first layer (scheduling or selector layer) so that every neuron will be exposed to the training objective (task).

After the training, the scheduler of the network can schedule the devices based on the weights or coefficients of the trained scheduling layer. The scheduled devices will transmit their measurements to the network that will input them to the decoding layers.

It is a nondeterministic polynomial (NP) problem to jointly optimize both the informativeness metric of a device for a task and the condition of its channel connections to the network. There are various task and various the channel condition. The advantage of the DNN is that the backward propagation (SGD) could propagate the task (training objective) from the last layer to the first layer. Then, all the neurons of this DNN work together to achieve the task. The first layer will regulate the scheduler and the rest layers will fuse and process the incoming information from multiple devices. Besides, the information about the path-loss rates among the devices are embedded in the training & test data set. As data-driven, this channel path-loss factor would be implicitly considered into the optimization by DNN. The autoencoder (DNN)-based scheduling methods disclosed herein provide a global optimization platform to do the joint optimization.

The scheduling layer is a full-connected linear layer: each its input is linked to each of its outputs. Each output is a weighed linear combination of all the inputs. The measurement information (raw information) from one device is regarded as one input (or one input dimension). If there are total N devices, there are N inputs. The scheduler would select the K most contributive devices from the total N candidates, which corresponds to K inputs being kept and processed by the subsequent decoding layers of the decoder portion of the autoencoder.

Unlike conventional linear layer, the training would polarize this layer. At the end of the training, although an output is a weighed linear combination from the N inputs, only one weight among N approach to 1 and the rest approach to 0. This indicates that the input with the weight close to 1 gets selected for this output. At the end of the training, the scheduling layer becomes a N-to-K selector.

To enable the training to polarize the first layer, a concrete distribution replaces discrete distribution. The concrete distribution is parameterized by a temperature. Along with the training (epoch by epoch), the temperature gets cooler and cooler so that the weights of a linear combination get more and more polarized.

The benefit to replacing the discrete distribution by a concrete distribution is that the latter is differentiable for SGD. When the temperature approaches to zero, the concrete distribution would be very similar to the discrete one. The concrete distribution with low temperature would make sure that only one of N weights approach to one and the rest are close to zero.

Kₘᵢₙ, the minimum number of devices to be scheduled, is relevant to the task. Different task may have different Kₘᵢₙ. To obtain the Kₘᵢₙ for a task, we can try the different Ks with the same training & test data set and the same training objective.

Kₘᵢₙ is the minimum K that not only fulfils the training objective but also doesn't result into any device to be selected more than once.

Over the scheduling layer trained with a concrete distribution, it is allowed that one input can be selected by more than one output. It means that although the AE specifies K outputs, the trained scheduling layer may indicate less than K input devices selected, because some of the chosen devices get selected for more than one output.

Kₘᵢₙ devices consist into a contributive set for the task. It means that the devices in the contributive set would be sufficient for the task (including a criteria). For example of classification task, a larger contributive set is needed to achieve a higher classification accuracy, and vice versa.

The determination of Kₘᵢₙ over N (Rₘᵢₙ=Kₘᵢₙ/N) for a task is similar to those of compression rate, sampling rate, and channel rate. From information theory, compression rate, sampling rate, and channel rate is to find the typical set related to a reconstruction task with an error criterion (square error or bit error). The typical set assumes that channel is stationary, either independent stationary as AWGN and binary erasure channel or stationary Markov chain. However, our Rₘᵢₙ=Kₘᵢₙ/N is to find the contributive set related to an arbitrary task with an arbitrary criterion in a diverse non-uniform erasure channel. As such, it appears that the contributive set is more general than the typical set.

Since Kₘᵢₙ relates the task (and its criteria) and channel conditions, the scheduler can cluster or group the selected devices by how many times they are selected. Once K>Kₘᵢₙ, some devices may get selected for more than once. The number of a device selected indicate how contributive it is for the task (and channel).

Both the observed phenomena and the channel are randomly varying, which comes up with some diversities on the measurements and on the channel conditions. To profit from the opportunistic diversities, the scheduler can first schedule a primary group of the devices that are selected for the most times. If the information from the primary group successfully reaches the network and provides enough confidence for the decoder to fulfil the task, then the scheduler could avoid scheduling the secondary groups. Otherwise, the scheduler could schedule the secondary group of devices and both the information from the primary group and the secondary group would input to the decoder together to improve its confidence. In some DNN cases, softmax is used to indicate a kind of confidence. For example, for 10-class classification, if none of softmax values reaches certain threshold, then the confidence is low. However, if one of 10 softmax values is obtrusive, this can provide a high confidence on the classification.

In practice, there may be one DNN trained with both the primary group input and the primary/secondary groups input. Alternatively, there may be one DNN trained with the primary group input and another DNN with the primary/secondary groups.

This concept is similar to a conventional HARQ-based channel coding scheme. Hybrid incremental redundancy scheduler (based on contributiveness) would take advantage of the diversity gain (measurements and channels). In comparison, HARQ-channel coding only takes advantage of the diversity gain of the channels. Therefore, the methods disclosed herein consider more diversities than conventional HARQ schemes.

Since the channels are varying, some devices in the contributive set may suffer from a sudden deep shadow, though their measurements may be extremely informative for the task. In this case, an alternative is to schedule a relaying in which these informative devices will transmit their measurement via less informative devices but with good channel conditions.

### AI-Based Sampling Algorithm

Although many of the examples described above are related to AI-based schedulers and scheduling algorithms, aspects of the present disclosure are also applicable AI-based sampling algorithms, some examples of which are described below.

The general goal of sampling is to find the most representative samples from which the original information that is being sampled can be reconstructed. Two common conventional sampling techniques are known as Nyquist sampling and compressed sensing. In Nyquist sampling, there is l₂ optimization and no discrimination among samples. In compressed sensing, there is l₁ optimization and no discrimination among samples

Aspects of the present disclosure provide intelligent sampling algorithms that have several advantages over the Nyquist and compressed sensing sampling algorithms, such as:
the most contributive samples are found for a downstream task;
Neither l₁ nor l₂ optimization.
There is discrimination among samples in terms of their contributiveness
Information fusion is needed
The right sampling sparsity can be found (which compressed sensing cannot do and Nyquist is limited to 2×fₘₐₓ)
Sparsity depends on the downstream task. (compressed sensing and Nyquist only deal with the sparsity with reconstruction).

### Other Intelligent Sampling Applications

### Interference Generation:

In Full-Duplex, interference is generated by a full-resolution sampling of transmission signals. Aspects of the present disclosure may be leveraged to sample much less to generate the interference, and can potentially be extended to other interference generation applications.

### Sparse Channel Chartering

Instead of high-resolution measuring radio channels over the entire cell, aspects of the present invention can be applied to find the most contributive spots to charter the cellular channels

### Ad-Hoc Network's Bottleneck Nodes

Aspects of the present invention can be applied to identify the bottleneck network nodes to maintain the connectivity associated to a task.

### Intelligent Quantization

Aspects of the present invention can be applied to find the minimum quantization for a specific task, i.e., the minimum number of quantization levels required for a specific task, which may vary significantly from task-to-task.

Examples of devices (e.g. ED or UE and TRP or network device) to perform the various methods described herein are also disclosed.

For example, a first device may include a memory to store processor-executable instructions, and a processor to execute the processor-executable instructions. When the processor executes the processor-executable instructions, the processor may be caused to perform the method steps of one or more of the devices as described herein. For example, the processor may cause the device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

### DEFINITIONS OF ACRONYMS

LTE Long Term Evolution
NR New Radio
BWP Bandwidth part
BS Base Station
CA Carrier Aggregation
CC Component Carrier
CG Cell Group
CSI Channel state information
CSI-RS Channel state information Reference Signal
DC Dual Connectivity
DCI Downlink control information
DL Downlink
DL-SCH Downlink shared channel
EN-DC E-UTRA NR dual connectivity with MCG using E-UTRA and SCG using NR
gNB Next generation (or 5G) base station
HARQ-ACK Hybrid automatic repeat request acknowledgement
MCG Master cell group
MCS Modulation and coding scheme
MAC-CE Medium Access Control-Control Element
PBCH Physical broadcast channel
PCell Primary cell
PDCCH Physical downlink control channel
PDSCH Physical downlink shared channel
PRACH Physical Random Access Channel
PRG Physical resource block group
PSCell Primary SCG Cell
PSS Primary synchronization signal
PUCCH Physical uplink control channel
PUSCH Physical uplink shared channel
RACH Random access channel
RAPID Random access preamble identity
RB Resource block
RE Resource element
RRM Radio resource management
RMSI Remaining system information
RS Reference signal
RSRP Reference signal received power
RRC Radio Resource Control
SCG Secondary cell group
SFN System frame number
SL Sidelink
SCell Secondary Cell
SPS Semi-persistent scheduling
SR Scheduling request
SRI SRS resource indicator
SRS Sounding reference signal
SSS Secondary synchronization signal
SSB Synchronization Signal Block
SUL Supplement Uplink
TA Timing advance
TAG Timing advance group
TUE Target UE
UCI Uplink control information
UE User Equipment
UL Uplink
UL-SCH Uplink shared channel

1. A method, the method comprising:
selecting, from a set of candidate devices, a first plurality of devices to schedule for uplink transmission, the selecting the first plurality of devices being based on a first corresponding contributiveness metric for each device of the first plurality of devices, wherein a first contributiveness metric for a first device of the first plurality of devices is related to a first downstream task in a wireless communication network and is indicative of:
how well the first device is able to successfully transmit information to the wireless communication network for the first downstream task, and
how informative the information provided by the first device is for the first downstream task; and
transmitting scheduling information for the first plurality of devices, the scheduling information indicating uplink radio resources allocated for the first plurality of devices.

2. The method of claim 1, wherein the uplink radio resources are allocated for the first plurality of devices by allocating, for each device of the first plurality of devices, corresponding uplink radio resources to each device based on the first corresponding contributiveness metric for the device.

3. The method of claim 2, wherein a device having a contributiveness metric indicative of a higher contributiveness for the first downstream task is allocated with more uplink radio resources than another device having another contributiveness metric indicative of a lower contributiveness for the first downstream task.

4. The method of claim 1, further comprising:
selecting, from the set of candidate devices, a second plurality of devices to schedule for second uplink transmission, the selecting the second plurality of devices being based on a second corresponding contributiveness metric for each device of the second plurality of devices, wherein the second corresponding contributiveness metric for each device of the second plurality of devices is related to a second downstream task in the wireless communication network different from the first downstream task, and wherein a second contributiveness metric for a second device of the second plurality of devices is indicative of:
how well the second device is able to successfully transmit second information to the wireless communication network for the second downstream task, and
how informative the second information provided by the second device is for the second downstream task; and
transmitting second scheduling information for the second plurality of devices, the second scheduling information for the second plurality of devices indicating second uplink radio resources allocated for the second plurality of devices.

5. The method of claim 1, wherein a contributiveness metric of a candidate device for the first downstream task is learned via machine learning using a machine learning module comprising a deep neural network (DNN) trained using raw test data received from at least a subset of the set of candidate devices as ML module input and one or more parameters for the first downstream task as ML module output to satisfy a training target related to the first downstream task.

6. The method of claim 5, wherein the DNN is configured as an autoencoder comprising at least two layers of neurons, wherein a first layer of the autoencoder is a linear fully-connected layer comprising K neurons having N inputs corresponding to the set of N candidate devices and K outputs, each of the K outputs of the first layer being a weighted linear combination of the N inputs, wherein, once trained, the first layer of the autoencoder is configured as an N-to-K selector that selects K inputs from the set of N inputs, and wherein K<N.

7. The method of claim 6, wherein one or more layers after the first layer of the autoencoder are configured as a decoder to perform decoding for the first downstream task utilizing the K outputs from the first layer as inputs to the decoder.

8. An apparatus comprising:
At least one processor; and
a memory storing processor-executable instructions that, when executed, cause the at least one processor to perform:
selecting, from a set of candidate devices, a first plurality of devices to schedule for uplink transmission, the selecting the first plurality of devices being based on a first corresponding contributiveness metric for each device of the first plurality of devices, wherein a first contributiveness metric for a first device of the first plurality of devices is related to a first downstream task in a wireless communication network and is indicative of:
how well the first device is able to successfully transmit information to the wireless communication network for the first downstream task, and
how informative the information provided by the first device is for the first downstream task; and
transmitting scheduling information for the first plurality of devices, the scheduling information indicating uplink radio resources allocated for the first plurality of devices.

9. The apparatus of claim 8, wherein the uplink radio resources are allocated for the first plurality of devices by allocating, for each device of the first plurality of devices, corresponding uplink radio resources to each device based on the first corresponding contributiveness metric for the device.

10. The apparatus of claim 9, wherein a device having a contributiveness metric indicative of a higher contributiveness for the first downstream task is allocated with more uplink radio resources than another device having another contributiveness metric indicative of a lower contributiveness for the first downstream task.

11. The apparatus of claim 8, wherein the processor-executable instructions, when executed, further cause the at least one processor to perform:
selecting, from the set of candidate devices, a second plurality of devices to schedule for second uplink transmission, the selecting the second plurality of devices being based on a second corresponding contributiveness metric for each device of the second plurality of devices, wherein the second corresponding contributiveness metric for each device of the second plurality of devices is related to a second downstream task in the wireless communication network different from the first downstream task, and wherein a second contributiveness metric for a second device of the second plurality of devices is indicative of:
how well the second device is able to successfully transmit second information to the wireless communication network for the second downstream task, and
how informative the second information provided by the second device is for the second downstream task; and
transmitting second scheduling information for the second plurality of devices, the scheduling information for the second plurality of devices indicating second uplink radio resources allocated for the second plurality of devices.

12. The apparatus of claim 8, wherein a contributiveness metric of a candidate device for the first downstream task is learned via machine learning using a machine learning module comprising a deep neural network (DNN) trained using raw test data received from at least a subset of the set of candidate devices as ML module input and one or more parameters for the first downstream task as ML module output to satisfy a training target related to the first downstream task.

13. The apparatus of claim 12, wherein the DNN is configured as an autoencoder comprising at least two layers of neurons, wherein a first layer of the autoencoder is a linear fully-connected layer comprising K neurons having N inputs corresponding to the set of N candidate devices and K outputs, each of the K outputs of the first layer being a weighted linear combination of the N inputs, wherein, once trained, the first layer of the autoencoder is configured as an N-to-K selector that selects K inputs from the set of N inputs, and wherein K<N.

14. The apparatus of claim 13, wherein one or more layers after the first layer of the autoencoder are configured as a decoder to perform decoding for the first downstream task utilizing the K outputs from the first layer as inputs to the decoder.

15. A non-transitory computer readable storage medium storing instruction thereon, when executed by a computer, cause the computer to perform operations, the operations comprising:
selecting, from a set of candidate devices, a first plurality of devices to schedule for uplink transmission, the selecting the first plurality of devices being based on a first corresponding contributiveness metric for each device of the first plurality of devices, wherein a first contributiveness metric for a first device of the first plurality of devices is related to a first downstream task in a wireless communication network and is indicative of:
how well the first device is able to successfully transmit information to the wireless communication network for the first downstream task, and
how informative the information provided by the first device is for the first downstream task; and
transmitting scheduling information for the first plurality of devices, the scheduling information indicating uplink radio resources allocated for the first plurality of devices.

16. The non-transitory computer readable storage medium of claim 15, wherein the uplink radio resources are allocated for the first plurality of devices by allocating, for each device of the first plurality of devices, corresponding uplink radio resources to each device based on the first corresponding contributiveness metric for the device.

17. The non-transitory computer readable storage medium of claim 16, wherein a device having a contributiveness metric indicative of a higher contributiveness for the first downstream task is allocated with more uplink radio resources than another device having another contributiveness metric indicative of a lower contributiveness for the first downstream task.

18. The non-transitory computer readable storage medium of claim 15, the operations further comprising:
selecting, from the set of candidate devices, a second plurality of devices to schedule for second uplink transmission, the selecting the second plurality of devices being based on a second corresponding contributiveness metric for each device of the second plurality of devices, wherein the second corresponding contributiveness metric for each device of the second plurality of devices is related to a second downstream task in the wireless communication network different from the first downstream task, and wherein a second contributiveness metric for a second device of the second plurality of devices is indicative of:
how well the second device is able to successfully transmit second information to the wireless communication network for the second downstream task, and
how informative the second information provided by the second device is for the second downstream task; and
transmitting second scheduling information for the second plurality of devices, the second scheduling information for the second plurality of devices indicating second uplink radio resources allocated for the second plurality of devices.

19. The non-transitory computer readable storage medium of claim 15, wherein a contributiveness metric of a candidate device for the first downstream task is learned via machine learning using a machine learning module comprising a deep neural network (DNN) trained using raw test data received from at least a subset of the set of candidate devices as ML module input and one or more parameters for the first downstream task as ML module output to satisfy a training target related to the first downstream task.

20. The non-transitory computer readable storage medium of claim 19, wherein the DNN is configured as an autoencoder comprising at least two layers of neurons, wherein a first layer of the autoencoder is a linear fully-connected layer comprising K neurons having N inputs corresponding to the set of N candidate devices and K outputs, each of the K outputs of the first layer being a weighted linear combination of the N inputs, wherein, once trained, the first layer of the autoencoder is configured as an N-to-K selector that selects K inputs from the set of N inputs, and wherein K<N.
